(19) United States
(12) Patent Application Publication
(10) Pub. No.: US 2002/0114038 A1
(43) Pub. Date: Aug. 22, 2002

(54) Optical communication system

(76) Inventors: Shlomi Arnon, Beer Sheva (IL); Nissim Attias, Raanana (IL); Paul Goldgeier, Haifa (IL); Yirmi Hauptman, Rishon Lezion (IL); Ronen Keshet, Tel Aviv (IL); Pini Sabach, Jerusalem (IL); Yoni Shiff, Rishon Lezion (IL)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/039,330

(22) Filed: Nov. 7, 2001

Related U.S. Application Data
(60) Provisional application No. 60/247,060, filed on Nov. 10, 2000.
(60) Provisional application No. 60/247,395, filed on Nov. 9, 2000.
(60) Provisional application No. 60/253,365, filed on Nov. 27, 2000.
(60) Provisional application No. 60/259,812, filed on Jan. 3, 2001.
(60) Provisional application No. 60/259,813, filed on Jan. 3, 2001.
(60) Provisional application No. 60/259,815, filed on Jan. 3, 2001.
(60) Provisional application No. 60/259,829, filed on Jan. 4, 2001.
(60) Provisional application No. 60/281,233, filed on Apr. 2, 2001.
(60) Provisional application No. 60/288,595, filed on May 3, 2001.

(51) Int. Cl. H04B 10/00; H04B 11/00

(52) U.S. Cl. 359/145; 379/56.1

(57) ABSTRACT

A method for transferring information within a cellular communications network (20), consisting of transmitting an optical carrier from a first network-element (26A) of the network, modulating the optical carrier (57, 59) with the information, and detecting the modulated optical carrier in an avalanche photo-diode (APD) (150) in a second network-element (24A) of the network so as to recover the information. The method includes altering a gain of the APD responsive to a level of the optical carrier so as to prevent saturation of the APD. Other methods and apparatus are also provided for transferring the information via the optical carrier, and also for using the information transferred.

### CROSS-REFERENCE TO RELATED APPLICATIONS

This application claims the benefit of U.S. Provisional Applications 60/247,060 filed Nov. 10, 2000, 60/247,395 filed Nov. 9, 2000, 60/253,365 filed Nov. 27, 2000, 60/259,812 filed Jan. 3, 2001, 60/259,813 filed Jan. 3, 2001, 60/259,815 filed Jan. 3, 2001, 60/259,829 filed Jan. 4, 2001, and 60/281,233 filed Apr. 2, 2001, which are assigned to the assignee of the present patent application and are incorporated herein by reference.

### FIELD OF THE INVENTION

The present invention relates generally to systems of communication, and specifically to systems for communicating between elements of a cellular telephone network via optical links.

### BACKGROUND OF THE INVENTION

Methods for transferring information and/or data via an optical link are well known in the art. Typical systems use a fiber optic or light guide to convey optical radiation, although other systems transfer optical radiation via substantially free space, e.g., through the atmosphere of the Earth. Some of the advantages of using optical radiation, as distinct from microwave or lower frequency radiation, are that the optical radiation has an inherently high carrying capacity due to its frequency being of the order of 100 THz. Other reasons for using optical radiation as a carrier are the availability of coherent optical sources which can be switched at speeds of the order of 100 GHz, and the fact that at least some of these coherent sources are implemented as monolithic solid-state devices.

Methods for communicating between elements of a cellular communication network via a path comprising at least some optical links are known in the art. For example, U.S. Pat. No. 6,049,593 to Acampora, whose disclosure is incorporated herein by reference, describes a cellular system wherein pico-cells, interconnected by short optical links of the order of 100 m length, comprise a larger cell of a communications network. Directly modulated lasers are typically used as transmission sources for optical links. However, the modulation has nonlinear characteristics, which in turn leads to reduced system performance. Performance degradation is caused in practice by severe weather, such as fog, cloud, high speed wind, and strong sunlight.

Optical links typically comprise receivers having a relatively small dynamic range. While the dynamic range may be increased by incorporating multiple amplification stages into the receiver, by methods known in the art, the stages may reduce the performance.

### SUMMARY OF THE INVENTION

It is an object of some aspects of the present invention to provide methods and apparatus for communicating via an optical link.

It is a further object of some aspects of the present invention to provide methods and apparatus for communicating between network-elements of a cellular communications network via an optical link.

In some embodiments of the present invention, a cellular communications network comprises a plurality of physically separated network-elements, each of the network-elements communicating with at least one other network-element in the network. The network-elements of the network can be chosen from a group comprising antennas, base-station transceiver systems (BTSs), base-station controllers (BSCs), and mobile transceivers. At least one of the network-elements in the network transmits information to another network-element by modulating an optical carrier with the information, the information being in the form of a radio-frequency (RF) signal, so generating a modulated carrier. The modulated carrier is preferably conveyed to the receiving network-element via free space, and/or via an optical guide such as a fiber optic.

The optical carrier can be generated by a light emitting diode (LED) or other incoherent radiation source. Alternatively, the optical carrier is generated by a source, such as a laser, emitting substantially coherent radiation. The modulated carrier can be transferred between the transmitting network-element and the receiving network-element via a guiding medium, such as a fiber optic or a light guide. Alternatively, the modulated carrier is transferred via a non-guiding medium, such as the atmosphere.

In some embodiments of the present invention, the receiving network-element comprises an avalanche photodiode (APD) which demodulates the carrier to recover the information. The APD is followed by one amplification stage, which together with the APD and feedback from the amplification stage to the APD controlling the gain of the APD, provides a detecting system for communication signals of the network having a high dynamic gain. Some embodiments of the present invention may use only one stage to achieve a high dynamic gain. In some embodiments, an alternative feedback loop from the APD is implemented. The alternative feedback loop comprises a return path to the source of the optical carrier, and the loop is implemented to control an output level of the carrier.

In some embodiments of the present invention, a gain device is switched into an RF amplifier of the transmitting network-element, when a detected level of a signal received by the transmitting network-element is below a predetermined threshold. A corresponding gain device is switched out of an RF amplifier in the receiving network-element, so that an overall gain of the system is substantially unchanged. When the signal level rises above the pre-determined threshold the gain device in the transmitter is removed and the device in the receiver is re-inserted. Some advantages of toggling the gain of the transmitting network-element, while maintaining a constant overall gain, are increased cellular system availability while keeping an overall system signal-to-noise ratio substantially constant.

In some embodiments of the present invention, the optical carrier is received in two or more optical receivers having different gain characteristics. Depending on the level of the received signal, a switch in the receiving network-element selects which of the optical receivers is used to regenerate the initial RF signal. Some advantages of some embodiments are that the ability to choose different receivers increases the overall dynamic range of the system.

In some embodiments of the present invention, the initial RF signal is converted to a digital signal by a broadband analog-to-digital converter. The digital signal is used to modulate the optical carrier, and the RF signal is recovered in the receiving network-element by a digital-to-analog converter.

In some embodiments of the present invention, the modulated optical carrier is split into two or more separate and adjustable optical carriers, which are transmitted separately by the transmitting network-element. A parameter such as a channel characteristic is measured for each optical carrier at the receiving network-element, and the respective carrier is adjusted responsive to the measurement to optimize transmission of the carrier. The two or more carriers are received and combined at the receiving network-element in a receiving block, and the initial RF signal is regenerated therein. Some advantages of some embodiments are that by transmitting the modulated optical carrier as a plurality of separate carriers, each being separately optimized, effects such as carrier attenuation in one of the carrier paths are mitigated.

In some embodiments of the present invention, the optical carrier is modulated by a plurality of RF sub-carriers, which are in turn respectively modulated by one or more signals which convey the information.

In some embodiments of the present invention, an optical pilot signal having known characteristics is transmitted from the transmitting network-element to the receiving network-element. A pilot receiver in the receiving network-element measures a received power level of the pilot signal. Deterioration in the carrier, indicated by a parameter of the carrier measuring quality of information transferred, such as a signal-to-noise ratio of the carrier, is determined from the received pilot signal level. The power of the modulated optical carrier is increased responsive to the measured pilot signal level, up to a maximum carrier power value depending on eye safety criteria, in order to overcome deterioration in the carrier.

If the carrier power is at its maximum value, and the carrier is still unduly deteriorated, the bandwidth of the carrier is reduced. Some advantages of some embodiments are that the adaptive combination of a variable power level and a variable bandwidth mitigates effects causing deterioration in the carrier. Typically, the effects include extreme weather conditions and pointing loss effects caused by inaccuracies in directing the optical carrier.

There is therefore provided, according to an embodiment of the present invention, a method for transferring information within a cellular communications network, including acts of:

transmitting an optical carrier from a first network-element of the network;

modulating the optical carrier with the information;

detecting the modulated optical carrier in an avalanche photo-diode (APD) comprised in a second network-element of the network so as to recover the information; and

altering a gain of the APD responsive to a level of the optical carrier so as to prevent saturation of the APD.

The act of transmitting the optical carrier may include transmitting coherent radiation from a laser diode.

Alternatively, the act of transmitting the optical carrier may include transmitting incoherent radiation from a light emitting diode.

The act of modulating the optical carrier may include modulating the carrier with one or more sub-carriers containing the information.

Furthermore, the act of detecting the modulated optical carrier may include measuring an output level generated by the APD, and altering the gain of the APD responsive to the level may include altering the gain responsive to the output level.

The act of measuring the output level may include utilizing a central processing unit (CPU) in the second network-element to measure an average output level, and altering the gain responsive to the output level may include utilizing the CPU to alter the gain.

The act of detecting the modulated optical carrier may include measuring an output level of the APD, and transmitting the optical carrier may include varying a power level of the optical carrier responsive to the output level of the APD.

The act of varying the power level of the optical carrier may further include:

transmitting a reverse optical carrier from the second network-element to the first network-element;

modulating the reverse optical carrier with an indication of the output level of the APD; and

varying the power output responsive to the indication.

The method may further include the act of modulating the reverse optical carrier with additional information.

Furthermore, the act of transmitting the optical carrier may include transmitting the optical carrier via a path between the first network-element and the second network-element including free space.

Alternatively or additionally, the act of transmitting the optical carrier may include transmitting the optical carrier via a path between the first network-element and the second network-element including a fiber optic.

The method may further include the act of altering the gain of the APD responsive to at least one of an optical background noise level of the optical carrier and an aggregate system noise, so as to prevent saturation of the APD.

There is further provided, according to an embodiment of the present invention, apparatus for transferring information within a cellular communications network, including:

a first network-element of the network, including:

an emitter which is adapted to transmit an optical carrier; and

a modulator which is adapted to modulate the optical carrier with the information; and

a second network-element of the network, including:

an avalanche photo-diode (APD) which is adapted to detect the modulated optical carrier so as to recover the information; and

a gain controller which is adapted to alter a gain of the APD, responsive to a level of the optical carrier, so as to prevent saturation of the APD.

The emitter may include a laser diode which transmits coherent radiation.

Alternatively, the emitter may include a light emitting diode which transmits incoherent radiation.

The modulator may be adapted to modulate the optical carrier with one or more sub-carriers including the information.

The gain controller may include a detector which is adapted to measure an output level generated by the APD, and the gain controller may be adapted to alter the gain of the APD responsive to the output level.

The second network-element may include a central processing unit (CPU) which is adapted to measure the output level as an average output level and to alter the gain responsive to the average output level.

Furthermore, the gain controller may be adapted to measure an output level of the APD, and the emitter may be adapted to vary a power output of the optical carrier responsive to the output level of the APD.

The second network-element may include a reverse-transmitting emitter which is adapted to transmit a reverse optical carrier which conveys an indication of the output level of the APD from the second network-element to the first network-element, and the emitter may be adapted to vary the power output responsive to the indication.

The second network-element may include a reverse modulator which modulates the reverse optical carrier with additional information.

The emitter may be adapted to transmit the optical carrier via a path between the first network-element and the second network-element including free space.

Alternatively or additionally, the emitter may be adapted to transmit the optical carrier via a path between the first network-element and the second network-element including a fiber optic.

The gain controller may be adapted to alter the gain of the APD responsive to at least one of an optical background noise level of the optical carrier and an aggregate system noise, so as to prevent saturation of the APD.

There is further provided, according to an embodiment of the invention, apparatus for transferring information within a cellular communications network, including:

a first network-element of the network, including:

a first amplifier which is adapted to receive and amplify a radio-frequency (RF) signal so as to generate a first-amplified-RF-signal;

a detector which indicates attainment of a predetermined level of the received-RF-signal;

a first gain device which is adapted to alter a gain of the first amplifier by a predetermined gain-value responsive to the attainment of the predetermined level; and

an optical transmitter which modulates an optical carrier with the first-amplified-RF-signal and which transmits the modulated carrier; and

a second network-element of the network, including:

an optical receiver which receives the modulated carrier and generates a received-RF-signal therefrom;

a second amplifier which is adapted to receive and amplify the recovered-RF-signal so as to generate a second-amplified-RF-signal; and

a second gain device which is adapted to alter a gain of the second amplifier by a value substantially equal to a negative of the predetermined gain-value responsive to the attainment of the predetermined level at the first network-element.

The detector may generate a change-gain signal responsive to the attainment of the predetermined level, and the optical transmitter may convey the change-gain signal to the optical receiver.

The second network-element may include a central processing unit (CPU) which incorporates the second gain device into the second amplifier responsive to the received change-gain signal.

There is further provided, according to an embodiment of the invention, apparatus for receiving information transmitted in a cellular communications network, including:

an optical assembly which is adapted to receive an optical carrier modulated with the information and output the received-modulated-carrier;

a first optical unit which is coupled to receive the received-modulated-carrier at a first end of the first optical unit and to convey the received-modulated-carrier therein;

a first receiver which is coupled to a second end of the first optical unit to receive a first fraction of the received-modulated-carrier and which, responsive thereto, is adapted to generate a first output representative of the information;

a second optical unit which is coupled to the first optical unit so as to convey a second fraction of the received-modulated-carrier into the second optical unit;

a second receiver which is coupled to the second optical unit so as to receive the second fraction of the received-modulated-carrier and which, responsive thereto, is adapted to generate a second output representative of the information; and

a switch which selects from the first and the second outputs responsive to a level of the received-modulated-carrier.

A ratio of the first fraction to the second fraction is may be included in an approximate range between 30:1 and 300:1.

The apparatus may further include:

a third optical unit which is coupled to the second optical unit so as to convey a third fraction of the received-modulated-carrier into the third optical unit; and

a third receiver which is coupled to the third optical unit so as to receive the third fraction of the received-modulated-carrier and which, responsive thereto, is adapted to generate a third output representative of the information,

wherein the switch may select from the first, second, and third outputs responsive to the level of the received-modulated-carrier.

A ratio of the second fraction to the third fraction may be included in an approximate range between 30:1 and 300:1.

The apparatus may further include:

a third optical unit which is coupled to the first optical unit so as to convey a third fraction of the received-modulated-carrier into the third optical unit; and

a third receiver which is coupled to the third optical unit so as to receive the third fraction of the received-modulated-carrier and which, responsive thereto, is adapted to generate a third output representative of the information,

and the switch may select from the first, second, and third outputs responsive to the level of the received-modulated-carrier and to an ability to operate of the second and third receivers.

At least one of the first and second optical units may include a fiber optic.

There is further provided, according to an embodiment of the invention, apparatus for transferring information within a cellular communications network, including:

a first network-element of the network, including:

an analog-to-digital converter (ADC) which is adapted to convert a radio-frequency (RF) signal to a digital signal, the RF signal being receivable from a transceiver operative within the network;

an optical modulator which is coupled to receive the digital signal and is adapted to modulate an optical carrier with the signal; and

a transmitter which is adapted to transmit the modulated optical carrier; and

a second network-element of the network, including:

a receiver which is coupled to receive the modulated optical carrier;

a demodulator which is adapted to recover the digital signal from the modulated optical carrier; and

a digital-to-analog converter (DAC) which is adapted to convert the digital signal so as to recover the RF signal.

A sampling rate of the ADC may be equal or greater than approximately twice a frequency of the RF signal bandwidth.

The digital signal may include a compressed digital signal generated by the ADC, and the DAC may be adapted to decompress the compressed digital signal.

There is further provided, according to an embodiment of the invention, apparatus for transferring information within a cellular communications network, including:

a first network-element of the network, including:

a splitter, which is adapted to receive an initial radio-frequency (RF) signal including the information and to split the signal into a first RF signal and a second RF signal;

a first optical transmitter which is coupled to modulate a first optical carrier with the first RF signal and to transmit the first modulated optical carrier; and

a second optical transmitter which is coupled to modulate a second optical carrier with the second RF signal and to transmit the second modulated optical carrier;

a second network-element of the network, including:

a first optical receiver which is adapted to receive and demodulate the first modulated optical carrier to recover the first RF signal;

a second optical receiver which is adapted to receive and demodulate the second modulated optical carrier to recover the second RF signal; and

a summer which is coupled to add the first and second recovered RF signals so as to regenerate the initial RF signal; and

a first feedback network, coupling the first optical receiver to the first optical transmitter, which alters a first characteristic of the first modulated optical carrier responsive to a first parameter indicative of a first quality of information transferred by the first modulated optical carrier measured at the second network-element.

The apparatus may further include a second feedback network which couples the second optical receiver to the second optical transmitter, and which alters a second characteristic of the second modulated optical carrier responsive to at least one of a second parameter indicative of a second quality of information transferred by the second modulated optical carrier measured at the second network-element and the first parameter.

A level of the first RF signal may be different from the level of the second RF signal.

Alternatively or additionally, a frequency of the first RF signal may be different from the frequency of the second RF signal.

A parameter of the first modulated optical carrier may be different from the parameter of the second modulated optical carrier, and the parameter may be chosen from a group including a wavelength, a polarization, and a power level.

The first modulated optical carrier may include substantially analog modulation, the first characteristic may include at least one of a bandwidth and a level of the first modulated optical carrier, and the first parameter may include a signal-to-noise ratio of the first modulated optical carrier.

Alternatively or additionally, the first modulated optical carrier may include substantially digital modulation, the first characteristic may include at least one of a bandwidth and a level of the first modulated optical carrier, and the first parameter may include a bit-error-rate of the first modulated optical carrier.

There is further provided, according to an embodiment of the invention, apparatus for transferring information within a cellular communications network, including:

a first network-element of the network, including:

a first mixer which is adapted to modulate a first RF sub-carrier with a first RF signal;

a second mixer which is adapted to modulate a second RF sub-carrier with a second RF signal;

a summer which is coupled to add the first and second modulated sub-carriers to generate a combined RF signal; and

an optical transmitter which is coupled to transmit an optical carrier modulated with the combined RF signal; and

a second network-element of the network, including:

an optical receiver which is adapted to receive the modulated optical carrier and to recover the combined RF signal;

a splitter which is coupled to recover from the combined RF signal the first modulated sub-carrier and the second modulated sub-carrier as separate signals;

a third mixer which is adapted to receive the first modulated sub-carrier and to recover the first RF signal; and

a fourth mixer which is adapted to receive the second modulated sub-carrier and to recover the second RF signal.

The third mixer may receive the first RF sub-carrier so as to recover the first RF signal, and the fourth mixer may receive the second RF sub-carrier so as to recover the second RF signal.

There is further provided, according to an embodiment of the invention, a method for transferring information within a cellular communications network, including the acts of:

receiving and amplifying, in a first amplifier included in a first network-element of the network, a radio-frequency (RF) signal so as to generate a first-amplified-RF-signal;

altering a gain of the first amplifier by a predetermined gain-value, responsive to the RF signal attaining a predetermined level;

modulating an optical carrier with the first-amplified-RF-signal and transmitting the modulated carrier;

receiving in an optical receiver included in a second network-element of the network the modulated carrier and generating a recovered-RF-signal therefrom;

receiving and amplifying the recovered-RF-signal in a second amplifier so as to generate a second-amplified-RF-signal; and

altering a gain of the second amplifier by a value substantially equal to a negative of the predetermined gain-value, responsive to the RF signal attaining the predetermined level.

The method may further include the acts of generating a change-gain signal in the first network-element responsive to the RF signal attaining the predetermined level, and conveying the change-gain signal to the second network-element.

There is further provided, according to an embodiment of the invention, a method for receiving information transmitted in a cellular communications network, including the acts of:

receiving in an optical assembly an optical carrier modulated with the information and outputting therefrom the received-modulated-carrier;

coupling the received-modulated-carrier into a first end of a first optical unit and conveying the received-modulated-carrier therein;

receiving a first fraction of the received-modulated-carrier in a first receiver coupled to a second end of the first optical unit and responsive thereto generating a first output representative of the information;

coupling a second optical unit to the first optical unit;

conveying a second fraction of the received-modulated-carrier into the second optical unit;

receiving in a second receiver coupled to the second optical unit the second fraction of the received-modulated-carrier and, responsive thereto, generating a second output representative of the information; and

selecting between the first and the second outputs responsive to a level of the received-modulated-carrier.

The acts of coupling may include forming a ratio of the first fraction to the second fraction that is included in an approximate range between 30:1 and 300:1.

At least one of the first and second optical units may include a fiber optic.

There is further provided, according to an embodiment of the invention, a method for transferring information within a cellular communications network, including the acts of:

converting, in an analog-to-digital converter (ADC), a radio-frequency (RF) signal to a digital signal, the RF signal being receivable by a transceiver operative within the network;

modulating an optical carrier with the digital signal; and

transmitting the modulated optical carrier from a transmitter included in a first network-element of the network; and

receiving and demodulating the modulated optical carrier in a receiver comprised in a second network-element of the network, so as to recover the digital signal; and

converting the digital signal in a digital-to-analog converter (DAC) so as to recover the RF signal.

The act of converting may include sampling at a sampling rate of the ADC that is equal to or greater than approximately twice a frequency of the RF signal.

The act of converting in the ADC may include compressing the digital signal to form a compressed digital signal and the act of converting in the DAC may include decompressing the compressed digital signal.

There is further provided, according to an embodiment of the invention, a method for transferring information within a cellular communications network, including the acts of:

receiving an initial radio-frequency (RF) signal comprising the information and splitting the signal into a first RF signal and a second RF signal;

modulating a first optical carrier with the first RF signal to produce a first modulated optical carrier and transmitting the first modulated optical carrier from a first optical transmitter in a first network-element of the network;

modulating a second optical carrier with the second RF signal to produce a second modulated optical carrier and transmitting the second modulated optical carrier from a second optical transmitter in the first network-element;

receiving in a first optical receiver in a second network-element of the network the first modulated optical carrier and demodulating the first modulated optical carrier to recover the first RF signal;

receiving in a second optical receiver in the second network-element the second modulated optical carrier and demodulating the second modulated optical carrier to recover the second RF signal;

coupling the first optical receiver to the first optical transmitter by a first feedback network which alters a first characteristic of the first modulated optical carrier, responsive to a first parameter indicative of a first quality of information transferred by the first modulated optical carrier measured at the second network-element; and

adding the first and second recovered RF signals to regenerate the initial RF signal.

The method may further include the act of coupling the second optical receiver to the second optical transmitter by a second feedback network which alters a second characteristic of the second modulated optical carrier, responsive to at least one of a second parameter indicative of a second quality of information transferred by the second modulated optical carrier measured at the second network-element and the first parameter.

The act of splitting may include providing a level of the first RF signal that is different from the level of the second RF signal.

Alternatively or additionally, the act of splitting may include providing a frequency of the first RF signal that is different from the frequency of the second RF signal.

The acts of modulating may include providing a parameter of the first modulated optical carrier that is different from a parameter of the second modulated-optical carrier, wherein the parameter is chosen from a group including a wavelength, a polarization, and a power level.

The first modulated optical carrier may include substantially analog modulation, the first characteristic may include at least one of a bandwidth and a level of the first modulated optical carrier, and the first parameter may include a signal-to-noise ratio of the first modulated optical carrier.

Alternatively or additionally, the first modulated optical carrier may include substantially digital modulation, the first characteristic may include at least one of a bandwidth and a level of the modulated first optical carrier, and the first parameter may include a bit-error-rate of the first modulated optical carrier.

There is further provided, according to an embodiment of the invention, a method for transferring information within a cellular communications network, including the acts of:

modulating a first RF sub-carrier with a first RF signal to form a first modulated sub-carrier;

modulating a second RF sub-carrier with a second RF signal to form a second modulated sub-carrier;

adding the first and second modulated sub-carriers to generate a combined RF signal;

transmitting an optical carrier modulated with the combined RF signal from a first network-element of the network;

receiving the modulated optical carrier in a second network-element of the network and recovering the combined RF signal;

separating the combined RF signal into the first modulated sub-carrier and the second modulated sub-carrier;

recovering the first RF signal from the first modulated sub-carrier; and

recovering the second RF signal from the second modulated sub-carrier.

There is further provided, according to an embodiment of the present invention, a method for allocating capacity to a network-element operating in a cellular communications network, including the acts of:

providing a plurality of spatially fixed network-elements, each network-element having a respective capacity for transmitting and receiving signals compatible with the cellular communications network;

coupling pairs of the plurality of network-elements by respective optical carriers, each carrier being modulated so as to convey the signals between the respective coupled pair of network-elements; and

transferring at least some of the capacity of the coupled network-elements therebetween via the optical carriers, responsive to a level of the signals detected by the plurality of network-elements.

The spatially fixed network-elements may be implemented to operate a plurality of cellular systems, and transferring at least some of the capacity may include transferring capacity between the cellular systems, and the plurality of cellular systems may include any of systems operating on two or more frequency bands, systems operating by two or more multiplexing methods, and systems operated by two or more different operators.

There is further provided, according to an embodiment of the present invention, apparatus for allocating capacity in a cellular communications network, including:

a first plurality of spatially fixed network-elements, each network-element having a respective capacity for transmitting and receiving signals compatible with the cellular communications network; and

a second plurality of optical carriers, each carrier coupling a pair of the network-elements and being modulated so as to convey the signals therebetween, and being adapted to transfer at least some of the capacity of the coupled network-elements therebetween, responsive to a level of the signals detected by the network-elements.

There is further provided, according to an embodiment of the present invention, a method for transferring information within a cellular communications network, including the acts of:

transmitting an optical carrier from a first network-element of the network to a second network-element of the network;

modulating the optical carrier with the information so as to transfer the information from the first network-element to the second network-element;

transmitting a pilot signal from the first network-element to the second network-element;

measuring a received power level of the pilot signal at the second network-element;

generating a mapping between the received power level of the pilot signal and a parameter indicative of a quality of the information transferred from the first network-element to the second network-element; and

adjusting at least one of a transmitted power level of the optical carrier and a communication bandwidth of the optical carrier, responsive to the received power level of the pilot signal and the mapping, so as to maintain a predetermined minimum quality of the information transferred from the first network-element to the second network-element.

The act of transmitting the pilot signal may include transmitting an optical pilot signal substantially collinearly with the optical carrier, and with a wavelength substantially different from the wavelength of the optical carrier.

Alternatively or additionally, the act of transmitting the pilot signal may include transmitting a pilot channel as a sub-carrier on the optical carrier.

The act of modulating the optical carrier may include modulating the optical carrier with an analog modulation, and the parameter indicative of the quality may include a signal-to-noise ratio of the optical carrier.

Alternatively or additionally, the act of modulating the optical carrier may include modulating the optical carrier with a digital modulation, and the parameter indicative of the quality may include a bit error rate of the optical carrier.

There is further provided, according to an embodiment of the present invention, apparatus for transferring information within a cellular communications network, including:

a first network-element of the network, including:

an optical emitter which transmits an optical carrier modulated with the information as a modulated optical carrier;

a pilot signal generator which transmits a pilot signal; and

a first central processing unit (CPU) which controls the emitter and the pilot generator;

a second network-element of the network, including:

a transducer which receives the modulated optical carrier and generates recovered information therefrom;

a detector which measures a received power level of the pilot signal;

a second CPU which receives the measured power level; and

a memory which stores a mapping between the received power level of the pilot signal and a parameter indicative of a quality of the recovered information, at least one of the first and second CPUs being adapted to adjust at least one of a transmitted power level of the optical carrier and a communication bandwidth of the optical carrier, responsive to the received power level of the pilot signal and the mapping, so as to maintain a predetermined minimum quality of the recovered information.

The pilot signal may include an optical pilot signal which is transmitted substantially collinearly with the modulated optical carrier, and which may have a wavelength substantially different from the wavelength of the modulated optical carrier.

Alternatively or additionally, the pilot signal may include a pilot channel operative as a sub-carrier on the optical carrier.

The modulated optical carrier may include an analog modulation, and the parameter indicative of the quality may include a signal-to-noise ratio of the modulated optical carrier.

Alternatively or additionally, the modulated optical carrier may include a digital modulation, and the parameter indicative of the quality may include a bit error rate of the modulated optical carrier.

The present invention will be more fully understood from the following detailed description of the preferred embodiments thereof, taken together with the drawings, in which:

### BRIEF DESCRIPTION OF THE DRAWINGS

FIG. 1 is a schematic diagram illustrating connections between network-elements of a cellular network, according to an embodiment of the present invention;

FIG. 2 is a schematic diagram showing details of two base-station transceiver system to antenna links, according to an embodiment of the present invention;

FIG. 3 is a schematic block diagram of an opto-electric transducer comprised in the links of FIG. 2, according to an embodiment of the present invention;

FIG. 4 is a schematic block diagram of a negative feedback loop comprised in the links of FIG. 2, according to an embodiment of the present invention;

FIG. 5 is a schematic block diagram of one of the links of FIG. 2, according to an embodiment of the present invention;

FIG. 6 is a schematic block diagram of one of the links of FIG. 2, according to an alternative embodiment of the present invention;

FIG. 7 is a schematic block diagram of one of the links of FIG. 2, according to a further alternative embodiment of the present invention;

FIG. 8 is a schematic block diagram of one of the links of FIG. 2, according to another embodiment of the present invention;

FIG. 9 is a schematic block diagram of the two links of FIG. 2, according to an alternative embodiment of the present invention;

FIG. 10 is a schematic diagram illustrating connections between network-elements of an alternative cellular network to that of FIG. 1, according to an embodiment of the present invention;

FIG. 11 is a schematic diagram of a coupling between an emitter and an opto-electric transducer in one of the links of FIG. 2, according to an embodiment of the present invention; and

FIG. 12 is a flowchart showing steps of a process for optimizing transmissions when the coupling of FIG. 11 is implemented, according to an embodiment of the present invention.

### DETAILED DESCRIPTION OF PREFERRED EMBODIMENTS

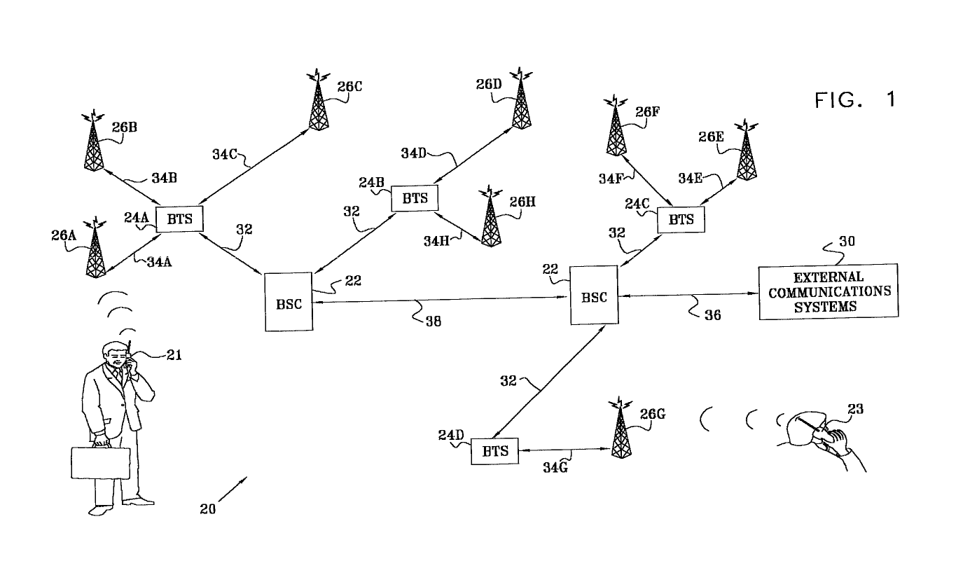

Reference is now made to FIG. 1, which is a schematic diagram illustrating connections between network-elements of a cellular network 20, according to an embodiment of the present invention. Network 20 comprises one or more base-station controllers (BSCs) 22. Each BSC 22 controls one or more base-station transceiver systems (BTSs) 24A, 24B, 24C, 24D, herein also collectively termed BTSs 24, via respective BSC-BTS links 32. Each BTS 24 is in turn coupled to one or more generally similar antennas 26A, 26B, . . . , 26H, herein also collectively termed antennas 26, via respective BTS-antenna links 34A, 34B, . . . , 34H, herein also collectively termed links 34. Each link 32, 34 acts as a full duplex coupling between end network-elements of the respective link.

Network 20 can operate according to one or more industry-standard multiplexing systems, such as a time domain multiple access (TDMA), a frequency domain multiple access (FDMA), and/or a code domain multiple access (CDMA) system, and in some embodiments operates in a radio-frequency (RF) band which is allocated for cellular communications. Network 20 is implemented so as to enable a mobile transceiver 21 within a region covered by antennas 26 to communicate with another mobile transceiver 23, via RF signals between antennas 26 and the mobile transceivers. In some embodiments at least one BSC 22 communicates with communication systems 30 external to network 20, such systems comprising any of a group consisting of a hard-wired telephone network such as a public switched telephone network (PSTN), a distributed packet transfer network such as the Internet, and one or more cellular networks not comprised in network 20. Communication between systems 30 and the BSC coupled to the systems can be via a BSC-external-system link 36.

In the disclosure and in the claims the term network-element refers to any of a base-station controller, a base-station transceiver system, a mobile transceiver, or an antenna adapted to operate and to communicate within a communications network as described above.

According to some embodiments, at least some of BSCs 22 transfer information between themselves, such information comprising network management and network operating data, as well as signals originating from mobile transceivers communicating within network 20. The latter occur, for example, when there is a handover from a cell controlled by one BSC to a cell controlled by a second BSC. The information between BSCs is transferred by a respective BSC-BSC link 38.

While not shown for clarity in FIG. 1, each link 32, 34, and 38 comprises two sets of terminations, each termination comprising circuitry, and a path between the terminations. The terminations act to couple their associated network-element with the path and may also act to convert radio-frequency (RF) signals generated in the associated network-elements to optical signals transmitted on the path. It is to be understood that in some embodiments of the invention, the terminations convert RF signals to optical signals, but it is to be understood that other mediums, such as RF, coax, fiber, and other mediums known to those of skill in the art may also be used. For example, link 34A comprises a BTS-termination in BTS 24A, an antenna-termination in antenna 26A, and a free air path between the terminations. As described in more detail below, RF signals generated in BTS 24A are converted to optical signals in the BTS-termination. The optical signals are then transmitted by the BTS-termination to the antenna-termination via the atmosphere, and the antenna-termination recovers the initial RF signal before conveying the signals to antenna 26A. In link 34A, a similar process applies to transmission of RF signals from antenna 26A to BTS 24A.

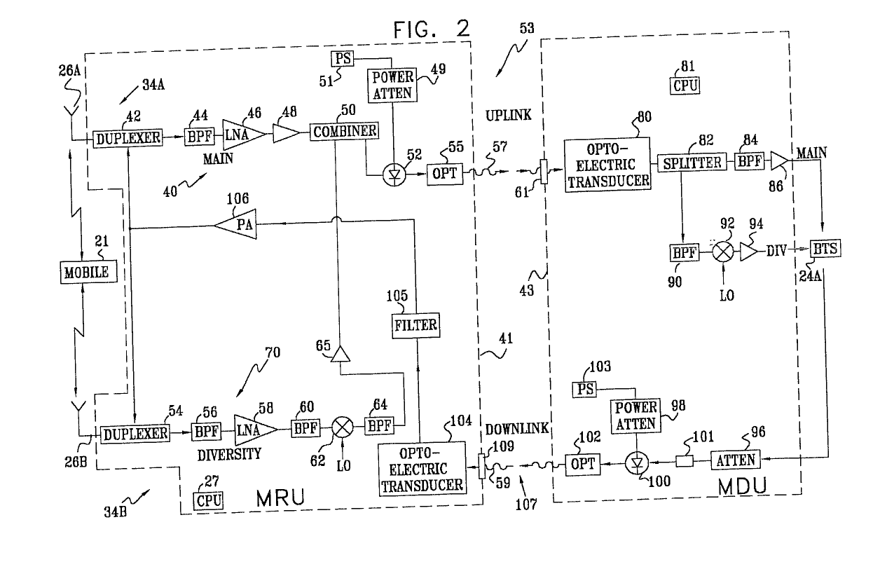

FIG. 2 is a schematic diagram showing details of BTS-antenna links 34A and 34B, according to an embodiment of the present invention. By way of example, links 34A and 34B comprise a common BTS-termination, herein termed a microwave donor unit (MDU) 43, and a common antenna-termination, herein termed a microwave remote unit (MRU) 41. Links 34A and 34B have, by way of example, a common uplink path 53 and a common downlink path 107, described in more detail below. As is also described in more detail below, both MRU 41 and MDU 43 act as duplexers, so that some circuit components of MRU 41 and MDU 43 are common to links 34A and 34B. It will be appreciated that link 34A and link 34B could be implemented as independent links having separate terminations, or as links having terminations common to other links. Each link or group of links will have a corresponding uplink path and a downlink path.

Antennas 26A and 26B are placed at positions physically distant from BTS 24A, so that a distance exists between the antennas and the BTS, such as on the order of 500 m, although the principles of the present invention apply to links of other lengths. Antennas 26A and 26B are themselves separated, the separation depending on the function which the antennas perform. For example, if antennas 26A and 26B are to act as antennas for separate cells, the antennas are positioned to be substantially at the center of their respective cells. Alternatively, if antennas 26A and 26B are to act as spatial diversity signal antennas for one cell, the antennas are separated by a distance of the order of one wavelength. Hereinbelow, antennas 26A are assumed to be used as spatial diversity antennas, so that antenna 26A receives a “main” signal, and antenna 263 receives a “diversity” signal.

MRU 41, as described in more detail hereinbelow, acts as a converter between RF and optical radiation, the radiation conveying information between mobile transceiver 21 and BTS 24A. MRU 41 comprises a central processing unit (CPU) 27 which provides overall control for operational parameters of components within MRU 41, such as a supply voltage or a gain setting of a component.

BTS 24A is coupled to MDU 43, which also acts as a converter between RF and optical radiation. MRU 43 comprises a CPU 81 which provides overall control for operational parameters of components within MRU 43. According to some embodiments, CPU 27 and/or CPU 81 also generate management signals, as are known in the art, for the purpose of monitoring and/or controlling components of links 34A and 34B in MRU 41 and MDU 43. Alternatively or additionally, monitoring and/or control of some of the components is implemented remotely.

In uplink path 53, mobile transceiver 21 transmits an uplink signal to main and diversity antennas 26A and 26B. In a main signal path 40 comprised in path 53, main antenna 26A receives its uplink signal as a main signal from transceiver 21, and transfers the signal to a duplexer 42. Duplexer 42 acts to convey the main signal from the antenna, and also to convey a downlink signal, described in more detail below, to the antenna. The main signal is passed to a band-pass filter (BPF) 44, which according to some embodiments operates in a bandwidth for conveying uplink signals defined by a protocol under which cellular network 20 operates, such as 824-849 MHz, and rejects signals at other frequencies. The filtered signal from BPF 44 is amplified by a low noise amplifier (LNA) 46, and a second amplifier 48, which provide a total gain of the order of 70 dB. The amplified uplink main signal is input to a combiner 50, which combines the signal from amplifier 48 with an amplified uplink diversity signal, described below.

In a diversity path 70 comprised in uplink path 53, diversity antenna 26B receives its uplink signal as a diversity signal from transceiver 21, and transfers the diversity signal to a duplexer 54. Duplexer 54 transfers the diversity signal to a BPF 56 and an LNA 58. Duplexer 54, BPF 56 and LNA 58 respectively function substantially as duplexer 42, BPF 44, and LNA 46, described above. The amplified filtered diversity signal from LNA 58 is transferred via a second BPF 60 to a mixer 62. Mixer 62 receives a local oscillator (LO) signal and the diversity signal from BPF 60, and generates an upper and lower intermediate frequency (IF). According to some embodiments, the LO has a frequency of the order of 56 MHz, although any other suitable LO frequency may be used. BPF 60 is implemented to provide high rejection of the local oscillator (LO) signal to prevent interference with LNA 58. According to some embodiments, a BPF 64 transmits the lower IF, i.e., within a bandwidth of 768-793 MHz if the network is operating at 824-849 MHz and if the LO frequency is 56 MHz, and rejects other frequencies including the upper IF. The lower IF is amplified by an amplifier 65, which supplies combiner 50 with an amplified uplink diversity signal, shifted in frequency from the uplink main signal.

Combiner 50 transfers the combined main and diversity signals as a modulating signal to a light emitter 52. Combiner 50 also sets a level of the transferred signals to provide a suitable modulation depth for emitter 52. According to some embodiments, emitter 52 comprises a solid state laser diode. Alternatively, emitter 52 is any other suitable electromagnetic wave emitter, known in the art, that emits waves which may be modulated and detected. The modulation is implemented as any type of analog or digital modulation, or combination thereof, known in the art. In some embodiments of the present invention, the modulation is applied using one or more sub-carriers, as is known in the art. In some embodiments of the present invention, emitter 52 is powered with a power supply (PS) 51 so that the average power output from the emitter is approximately constant. In alternative embodiments of the present invention, an attenuator 49 controls the power output from emitter 52, as described in more detail below.

Emitter 52 generates coherent radiation having a wavelength in an approximate range of 850 nm-1,550 nm at a power in an approximate range of 1-500 mW, or alternatively at any other convenient power. The radiation is collimated to a substantially parallel beam by transmission collimating optics 55. For example, if emitter 52 comprises a laser diode, optics 55 comprises a combination of one or more lenses and/or other optical components such as fiber optics, which are implemented by methods known in the art to collimate the generally diverging beam which radiates from the diode. According to some embodiments, the collimated beam has a divergence in an approximate range of 0.5-2.5 mrad. In some embodiments of the present invention, the beam is transmitted as a free-space beam via a path 57 to MDU 43, in which case the power emitted by emitter 52 is preferably less than a power level which causes deleterious effects when incident on a person. In other embodiments of the present invention, path 57 comprises a fiber optic, and optics 55 comprises coupling optics to the fiber optic.

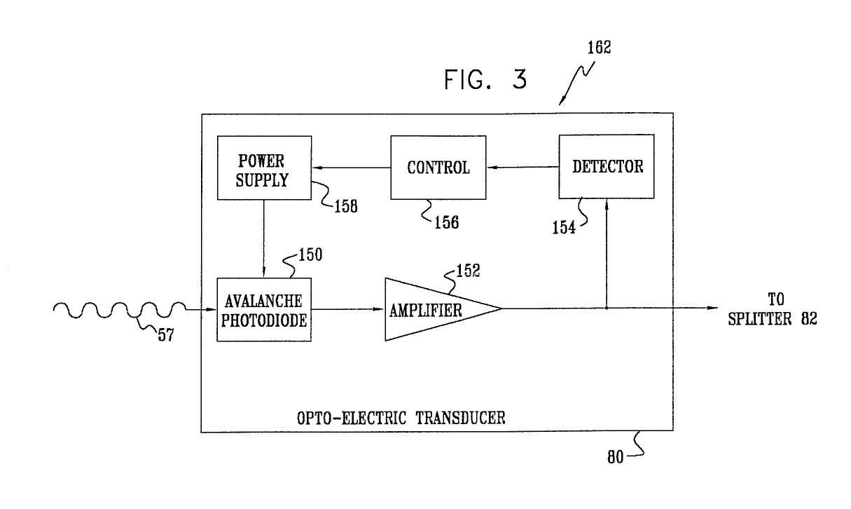

The radiation from emitter 52 is received by receiving collimating optics 61 in MDU 43. Optics 61 focus the received radiation onto an opto-electric transducer 80 in MDU 43, which converts the radiation into electrical signals, thus recovering the electric signals output from combiner 50. Transducer 80 also provides an initial pre-amplification stage for the signals. The operation and implementation of transducer 80 is described in more detail below with reference to FIG. 3.

The pre-amplified signals from transducer 80 are transferred to a splitter 82, which comprises a filter that separates the main signals from the diversity signals. The main signals are conveyed via an isolating BPF 84 and a main amplifier 86 to BTS 24A. The diversity signals are conveyed via an isolating BPF 90 to a mixer 92. Mixer 92 converts the diversity signals to their original frequency by mixing the signals from splitter 82 with substantially the same LO frequency as used in MRU 41. The converted diversity signals are amplified in an amplifier 94 before being transferred to BTS 24A. BTS 24A receives both the main and the diversity signals, and operates on the signals according to the protocol being utilized by network 20.

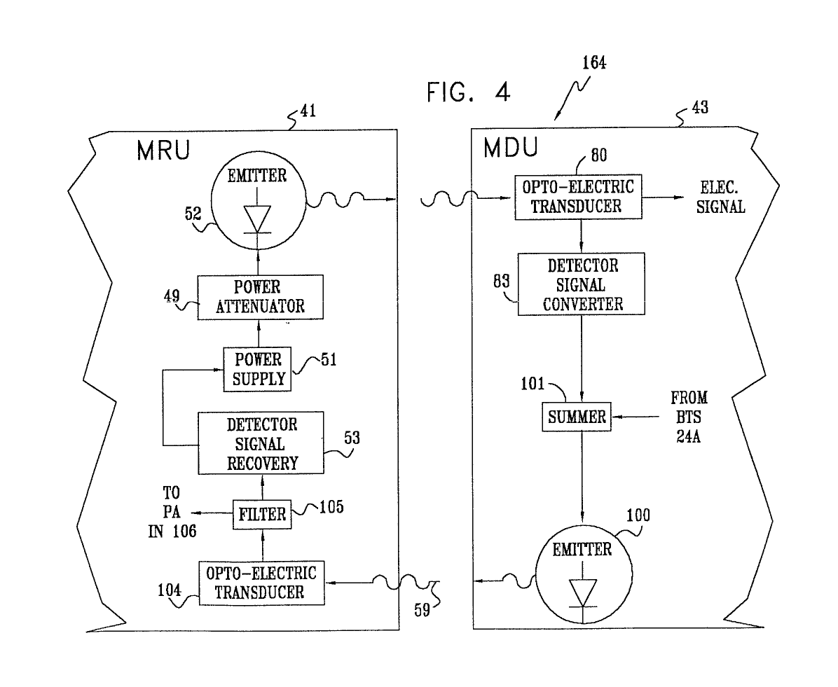

BTS 24A also supplies downlink signals to transceiver 21, via downlink path 107, which according to some embodiments may be in a frequency band 869-894 MHz, although any other suitable frequency band available in the communication protocol implemented in network 20 may be used. The signals transfer to a variable attenuator 96, which sets a level of the signals so as to provide a suitable modulation depth for an optical emitter 100. In some embodiments of the present invention, signals from attenuator 96 transfer to emitter 100 via a summer 101, whose function is explained with reference to FIG. 4 below. In other embodiments summer 101 is not present, and signals from attenuator 96 are input directly to emitter 100. Emitter 100 is preferably substantially similar in operation and implementation to emitter 52, providing an electromagnetic wave output which is modulated by one of the methods described above with respect to emitter 52. In some embodiments of the present invention, emitter 100 is powered with a power supply 103 so that the power output from the emitter is approximately constant. In alternative embodiments of the present invention, an attenuator 98 controls the power output from emitter 100, as described in more detail below.

Radiation from emitter 100 is collimated by transmission collimating optics 102. Optics 102 are generally similar to optics 55, and are implemented, depending on emitter 100, so as to generate a beam having a divergence in an approximate range of 0.5-2.5 mrad. The radiation from emitter 100 is transmitted via a path 59, comprising free space and/or a fiber optic, and is received by receiving collimating optics 109 in MRU 41. Optics 109 focus the received radiation onto an opto-electric transducer 104 in MRU 41, which converts the radiation into electrical signals, thus recovering the electric signals input to the emitter. According to some embodiments, transducer 104 is substantially similar in operation and implementation to transducer 80, providing a pre-amplification stage for the recovered signals from the emitter 100.

In some embodiments of the present invention, the recovered pre-amplified signals are transferred via a filter 105, whose function is described with reference to FIG. 4, to a power amplifier (PA) 106. In other embodiments of the present invention filter 105 is not present, and the recovered pre-amplified signals are transferred directly to PA 106. PA 106 increases the power level to a suitable final output level, and the amplified signals from PA 106 are transferred to duplexers 42 and 54. The final output signals are then radiated from antennas 26A and 26B to mobile transceiver 21.

FIG. 3 is a schematic block diagram of opto-electric transducer 80, according to some embodiments of the present invention. The explanation hereinbelow for transducer 80 also applies, mutatis mutandis, to transducer 104. According to some embodiments, components within transducer 80 are under the overall control of CPU 81. Transducer 80 comprises an avalanche photodiode (APD) 150, such as a PD 8042 produced by Mitsubushi Electric Corporation of Tokyo, Japan. Alternatively, APD 150 comprises any other avalanche photodiode capable of detecting radiation emitted by emitter 52. In some preferred embodiments of the present invention, APD 150 comprises an integral high voltage power supply (PS) 158 implemented to supply the photodiode. In other preferred embodiments of the present invention, power supply 158 is a separate component within transducer 80.

A current output from APD 150 is dependent on an optical power level of the optical carrier, together with an optical background noise level of the carrier and an aggregate system noise. The current output from APD 150 is input to a low noise pre-amplifier 152, such as a trans-impedance amplifier ATA 30013D1C produced by Anadigics Incorporated, of Warren, N.J. or a trans-impedance amplifier having generally similar properties. A voltage level of the output of amplifier 152 is measured in a detector 154. According to some embodiments, the level measured by detector 154 is an average level, the type and parameters of the averaging being set by CPU 81, and is a function of the optical power level, the optical background noise level, and the aggregate noise.

According to some embodiments, the measured output from detector 154 is utilized by a control unit 156 to set a voltage output applied by PS 158 to APD 150. Alternatively, the output of detector 154 is used by CPU 81 to set the voltage output of PS 158. The voltage output applied to APD 150 sets a gain of the APD. In some embodiments of the present invention, the gain of APD 150 is varied so that the dynamic range of transducer 80 is of an order of 50 dB while the APD remains in its operational range, so that saturation of the APD, due to too high a level of the carrier or of the noise level, is prevented.

It will be appreciated that amplifier 152, detector 154, control unit 156, and PS 158 comprise a first negative feedback loop 162 operating as a gain controller for APD 150, for a given level of radiation received at the APD. Some embodiments of the present invention comprise a second negative feedback loop, used to control the level of radiation incident on APD 150, as described hereinbelow.

FIG. 4 is a schematic block diagram of a second negative feedback loop 164 comprising attenuator 49, summer 101, and filter 105, according to an embodiment of the present invention. In loop 164, the level measured by detector 154, in transducer 80, is output to a detector signal converter 83 comprised in MDU 43. Converter 83 comprises components of MDU 43 described above, and/or components of BTS 24A, which are enabled to provide a modulating input signal to emitter 100 representative of the detector signal level output by detector 154. Alternatively or additionally, converter 83 comprises one or more other components known in the art which are enabled to provide a modulating input signal to emitter 100 representative of the detector signal level. For example, converter 83 comprises CPU 81, which receives the voltage from detector 154 and transforms the voltage into one of the management signals generated by the CPU. Alternatively, detector signal converter 83 comprises a voltage-to-frequency oscillator, generating a frequency responsive to the detector signal voltage output by detector 154. The frequency generated may be used to modulate a sub-carrier generated within converter 83, which modulated sub-carrier is combined with the downlink signal being transmitted from BTS 24A, and the combined signal is then used to modulate emitter 100. Other systems for generating a modulating input signal to emitter 100 representative of the detector signal level will be apparent to those skilled in the art. All such systems are comprised in the scope of the present invention. The modulating signal from converter 83 is combined in summer 101 with the signal from BTS 24A (conveyed via attenuator 96) and the combined signal is used to modulate emitter 100, thus generating a downlink signal comprising an indication of the power level received by transducer 80.

Transducer 104 receives the downlink signal from emitter 100, and transfers the signal to filter 105. Filter 105 separates out the power level indication from the downlink signal, substantially the rest of the downlink signal being conveyed to PA 106, for processing as described above. The power level indication is conveyed to a detector signal recovery device 53. Device 53 comprises components of MRU 41 described above which are enabled to recover a signal representative of the detector signal level output by detector 154 from the power level indication. It will be appreciated that the components comprised in device 53 depend on the method used by converter 83 to perform its conversion. For example, if converter 83 utilizes management signals as described above, recovery device 53 can comprise CPU 27 which is used to generate the recovered signal. Alternatively, device 53 can comprise other components selected, as will be apparent to those skilled in the art, according to the system used by converter 83 to perform its conversion. For example if converter 83 utilizes a voltage-to-frequency oscillator, device 53 can comprise a frequency-to-voltage converter.

The recovered signal is utilized directly, or by other methods known in the art such as by signals generated from the recovered signal by CPU 27, as a control signal for attenuator 49. Attenuator 49 is enabled to control PS 51, which in turn sets a power output of emitter 52. The control signal, generated as described hereinabove by second feedback loop 164, maintains the power received at transducer 80 as constant as possible.

According to some embodiments, by using an APD with one stage of amplification a high dynamic range is achieved, without incurring losses which may be found in multiple stage optical receivers providing high dynamic range as are known in the art. It will be appreciated that some embodiments of the present invention, as described above with reference to FIGS. 2, 3, and 4, use an APD with a gain control to prevent saturation of the APD. While the above embodiments have been described with reference to a BTS-antenna link, it will be appreciated that all links between network-elements of a cellular communication system, wherein the link comprises an avalanche photodiode with a gain control for preventing saturation of the APD, are included within the scope of the present invention.

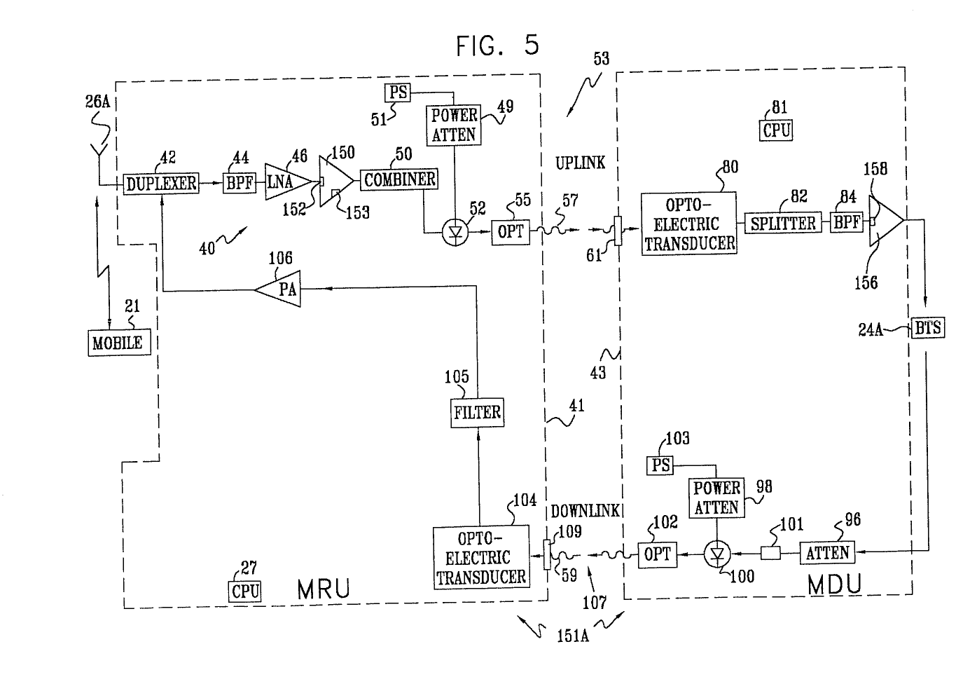

FIGS. 5-8 are schematic block diagrams of links 151A, 171A, 191A, and 211A between antenna 26A and BTS 24A, according to some respective embodiments of the present invention. Apart from the differences described below, the operation of each of alternative links 151A, 171A, 191A, and 211A is generally similar to that of link 34A (FIGS. 1-4), so that components indicated by the same reference numerals in links 34A and the respective alternative links are generally identical in construction and in operation. Those skilled in the art will be able to apply the differences described hereinbelow to implementation of other links such as link 34B.

FIG. 5 is a schematic block diagram of link 151A between antenna 26A and BTS 24A. (For clarity, all components unique to link 34B have been deleted from FIG. 5.) The description hereinbelow assumes that link 151A is implemented in MRU 41 and MDU 43 by replacing and/or removing components of link 34A described above with reference to FIGS. 2-4.

In MRU 41 an amplifier 150 replaces amplifier 48. Amplifier 150 comprises a detector circuit 152 which measures a threshold level of the signal from LNA 46. Amplifier 150 also comprises a gain device 153, having a gain denoted by +G, which may be applied on a switchable basis to signals in the amplifier. The switching is preferably under control of CPU 27.

In MDU 43 an amplifier 156 replaces amplifier 86. Amplifier 156 comprises a gain device 158, having an opposite gain (denoted by −G) to that of gain device 153. Gain device 158 may be also be applied on a switchable basis to signals in amplifier 156. The switching is preferably under control of CPU 81.

During operation of link 151A, detector circuit 152 measures the level of the signal input into amplifier 150. If the level falls below a threshold signal level, denoted by Sₜ, gain device 153 is incorporated into the overall gain of amplifier 150. The incorporation is monitored by CPU 27, which conveys a change-gain signal via uplink 53 to MDU 43 indicating that the incorporation has occurred. On receipt of the change-gain signal, gain device 158 is incorporated into amplifier 156. A reverse process to that described hereinabove is implemented if the signal level measured by detector circuit 152 rises above level Sₜ, at which point gain devices 153 and 158 are withdrawn from their respective amplifiers.

It will be appreciated that by switching gains of amplifiers 150 and 156 in opposition, an overall gain of uplink 53 remains substantially constant. However, a dynamic range required by emitter 52 is reduced compared to the range that would be required if there were no gain switching, since low signal levels from amplifier 46 are compensated, before being applied to emitter 52, by increased gain in amplifier 150. Thus, a signal-to-noise ratio, which would otherwise have become very low in the absence of gain switching, is significantly increased for low signal levels from amplifier 46.

In some embodiments a system similar to that described hereinabove is utilized for optical links where weather effects, such as fog, are likely to reduce a signal level received at MDU 43 compared to the signal level under clear conditions. Other effects which may reduce the signal level include pointing loss (of collimating optics) and attenuation by the atmosphere.

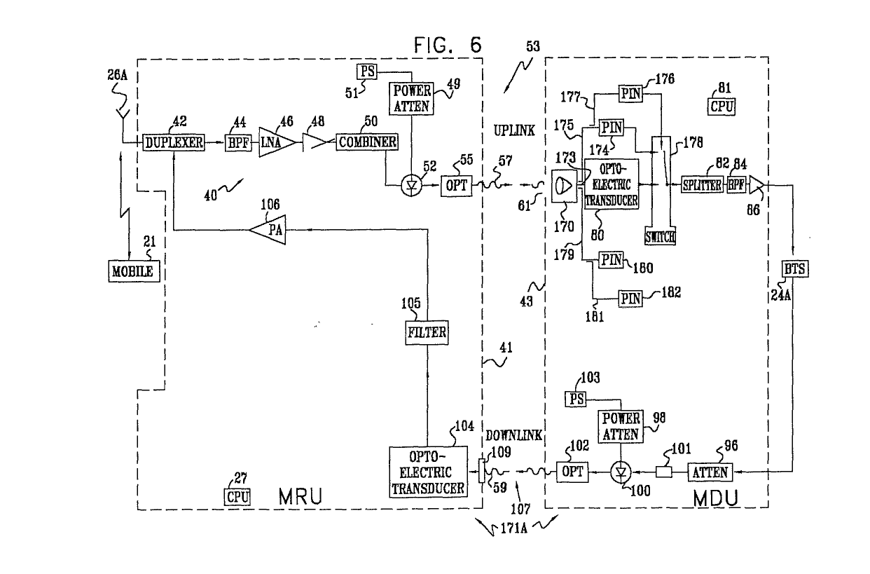

FIG. 6 is a schematic block diagram of a link 171A between antenna 26A and BTS 24A, according to another embodiment of the present invention. The description hereinbelow assumes that link 171A is implemented in MRU 41 and MDU 43 by replacing and adding components to link 34A.

In MDU 43 optics 170 replace optics 61. Optics 170 focus incoming radiation onto a fiber optic 173, which transfers the radiation to transducer 80, acting as a first radiation receiver. A second fiber optic 175 is coupled to fiber optic 173, so as to receive a fraction of the radiation transferred in fiber optic 173, and the second fiber optic transfers radiation therein to a second receiver 174. According to some embodiments, the fraction lies in an approximate range 0.3%-3%. In some embodiments receiver 174 is a radiation receiver comprising a PIN diode detector whose output is amplified by a trans-impedance amplifier. Except for APD 150 being replaced by the PIN diode, receiver 174 is generally the same in operation and construction as transducer 80. It will be understood that receiver 174 is significantly less sensitive than transducer 80, because of the different photo-diodes used in the two circuits.

A third fiber optic 177 is coupled to fiber optic 175, so as to receive generally the same fraction as described above of the radiation transferred in fiber optic 175, and the third fiber optic transfers radiation therein to a third receiver 176. According to some embodiments receiver 176 comprises a PIN diode coupled to a matching resistive load, the output of the receiver being taken from the load without amplification. Thus, receiver 176 is significantly less sensitive than receiver 174, because of the lack of amplification in receiver 176.

A switch 178, in some embodiments under the control of CPU 81, is connected to outputs of transducer 80, receiver 174, and receiver 176. Switch 178 is able to choose which output is to be conveyed to splitter 82, the choice being made according to an incoming signal level at optics 170. In some embodiments, switch 178 defaults to receiving output from transducer 80, and continues to receive output from the transducer for low incoming signal levels. In the event that the signal to transducer 80 increases, the transducer approaches saturation, and this is detected by CPU 81. CPU 81 thereupon alters switch 178 to receive output from receiver 174. As the signal level continues to increase, receiver 174 approaches saturation, and switch 178 is switched by CPU 81 to receiving output from receiver 176.

The system described above comprises multiple cascaded receivers of different sensitivities, the least sensitive receiver being coupled directly to receive the optical input signal, and more sensitive receivers receiving the optical signal via respective attenuators. It will be appreciated that such a system of cascaded receivers, coupled to progressively stronger attenuators, enables a system of wide dynamic range to be implemented from receivers which inherently have a smaller dynamic range.

In some embodiments of the present invention, receivers 174 and 176 and their coupled fiber optics 175 and 177 are duplicated by respective receivers 180 and 182 and respective fiber optics 179 and 181. The duplicate receivers and fiber optics are coupled to fiber optic 173 in substantially the same manner as receivers 174, 176 and fiber optics 175, 177. When receivers 180 and 182 are implemented, switch 178 is implemented so as to be able to select these receivers, as well as receivers 174 and 176. Receivers 180 and 182 may thus act as redundant receivers, and are selected by switch 178 if receiver 174 or receiver 176 becomes inoperative.

In some embodiments, an optical unit, comprising optical elements such as one or more lenses and/or one or more fully or semi-reflecting mirrors and/or one or more beam-splitters, replaces a respective fiber optic and its coupling. Methods of implementation of such an optical unit which may be used in place of a fiber optic will be apparent to those skilled in the art. All such optical units are to be considered as being comprised within the scope of the present invention.

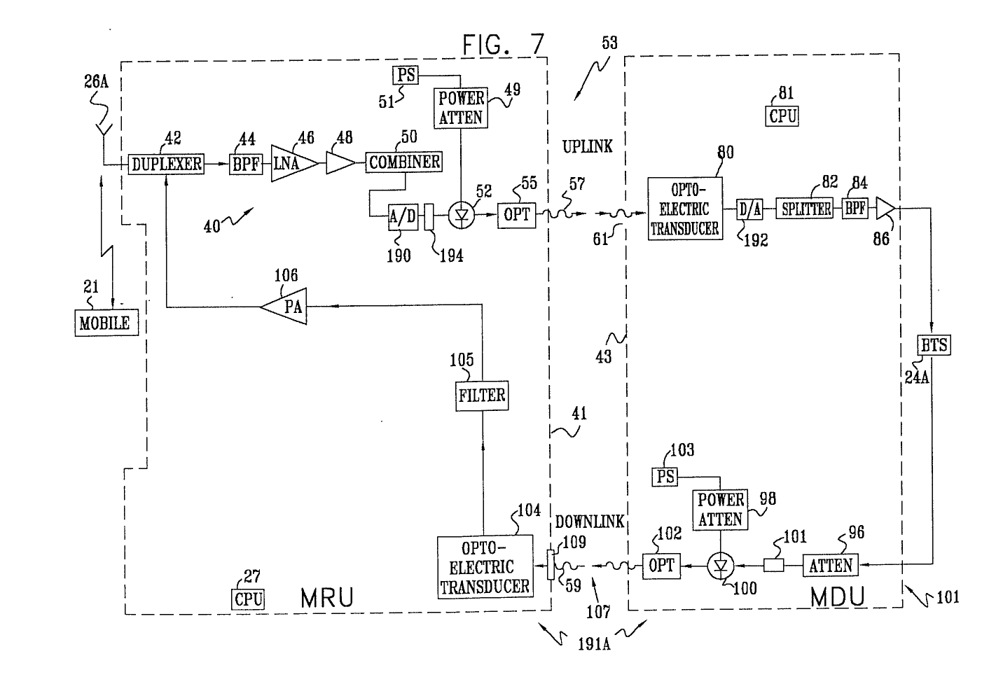

FIG. 7 is a schematic block diagram of a link 191A between antenna 26A and BTS 24A, according to an alternative embodiment of the present invention. The description hereinbelow assumes that link 191A is implemented in MRU 41 and MDU 43 by adding components to link 34A.

An analog-to-digital converter (AIDC) 190 is interposed between combiner 50 and emitter 52. In some embodiments, the sampling rate of ADC 190 is implemented to be equivalent to at least twice the highest frequency of the RF signal bandwidth input to MRU 41. In some embodiments of the present invention ADC 190 comprises one or more filters, signal processing units, and/or frequency converters, to achieve an appropriate sampling rate. The output of ADC 190 provides a parallel digital output, which is converted in a parallel-serial converter 194 to a serial digital output. The serial digital output is input to emitter 52, which radiates a corresponding pulsed modulated optical output via optics 55 to MDU 43. In MDU 43 a digital-to-analog converter (DAC) 192 is interposed between transducer 80 and splitter 82. In some embodiments of the present invention DAC 192 comprises one or more filters, signal processing units, and/or frequency converters, to achieve appropriate recovery of the signal. DAC 192 converts the received pulsed modulated output so as to recover the original RF signals and conveys the signals to splitter 82.

By digitizing the transmission of data between MRU 41 and MDU 43, standard signal enhancing and improvement techniques, as are known in the art, can be applied to the data. For example, CPU 27 transmits the digitized signals as data packets, and each data packet may have a checksum incorporated into the packet. CPU 81 checks the checksum, and the data packets having incorrect checksums are resent. In some embodiments data from ADC 190 and/or converter 194 is compressed, the compressed data modulates emitter 52, and DAC 192 recovers the compressed data and decompresses it to recover the original RF signals.

It will be appreciated that digitization as described with reference to FIG. 7 enables free-space optical systems described hereinabove to operate more efficiently, such as with reduced laser power, use of standard components, and/or use of signal processing.

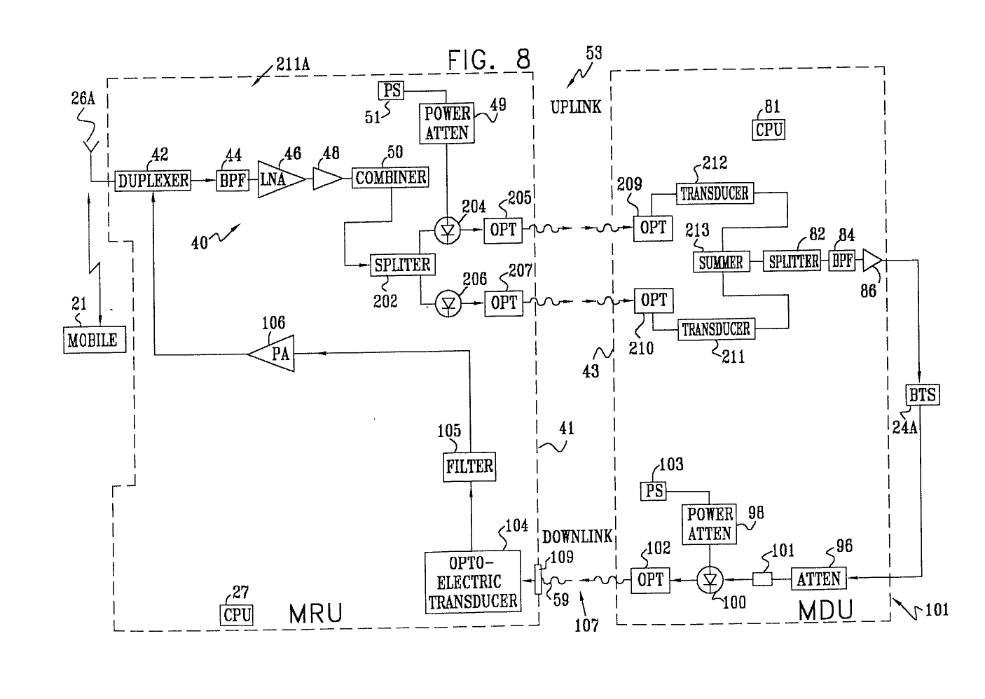

FIG. 8 is a schematic block diagram of a link 211A between antenna 26A and BTS 24A, according to a further alternative embodiment of the present invention. The description hereinbelow assumes that link 211A is implemented in MRU 41 and MDU 43 by adding and replacing components in link 34A.

In MRU 41 a splitter 202 is added after combiner 50. Splitter 202 is implemented so as to divide the RF signal from combiner 50 into two, non-identical signals. For example, splitter 202 may output two signals having an amplitude ratio equal to n:1, where n is a number substantially different from 1, such as 2, but which are otherwise substantially similar. Each signal output from splitter 202 is used to separately modulate respective optical emitters 204 and 206, which replace emitter 52, and which each function substantially as emitter 52. Radiation from emitters 204 and 206 is transmitted by respective collimating transmission optics 205 and 207 to MDU 43 as two separate beams.

In MDU 43 receiving optics 61 are replaced by receiving collimating optics 209 and 210, which respectively receive beams from transmission optics 205 and 207. Each beam is respectively focussed onto transducers 212 and 211, which replace transducer 80, and which each function substantially as transducer 80. Outputs from transducers 211 and 212 are summed in a summer 213, which is implemented to recover the initial RF signal. The recovered RF signal is input to splitter 82.

Dividing the radiation from MRU 41 into two separate beams improves an overall signal-to-noise ratio in poor reception conditions, compared to the case with one beam. In poor reception conditions, such as in a case when atmospheric disturbances are present, a single beam may be virtually completely attenuated at certain times. In the double beam system described hereinabove the chance of both beams being substantially simultaneously completely reduced is significantly less.

It will be appreciated that splitter 202 may be implemented to split the RF signal by one or more methods different from the amplitude splitting method described above. For example, splitter 202 may comprise a frequency filter which divides the RF signal into two or more filter bands, so reducing cross-talk between the modulated beams. Some of the bands modulate emitter 204, and the remaining bands modulate emitter 206. Summer 213 is implemented to recover the RF signal by summing the separate frequencies recovered in transducers 211 and 212. It will also be understood that since emitters 204 and 206 are distinct, they may be implemented with different characteristics, and even by different systems, such as one being a LED and another being a laser. Furthermore, emitters 204 and 206 may be implemented to emit at different wavelengths and/or different polarizations and/or power levels, enabling system performance to be optimized. In this case optics 209, 210 and transducers 211, 212 are altered as necessary so as to detect the incoming beams.

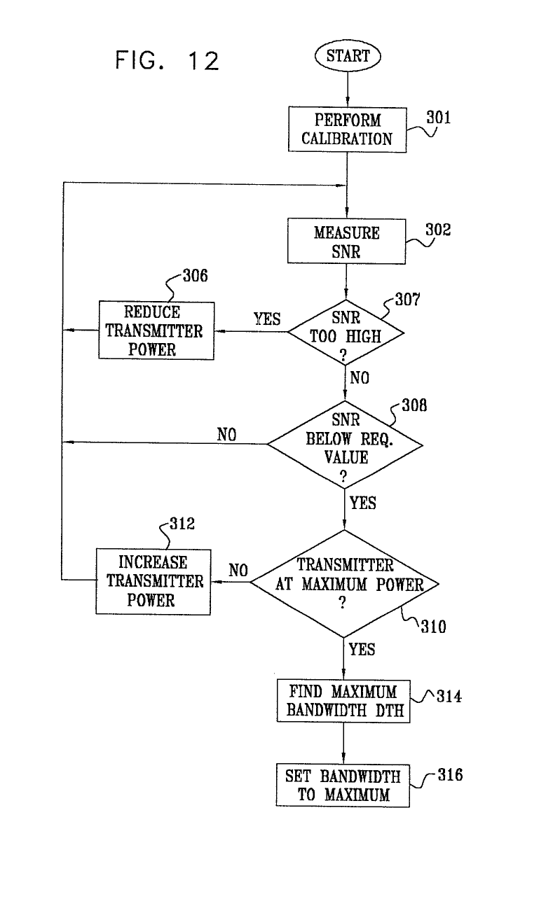

In some embodiments, a first feedback circuit is implemented between transducer 212 and emitter 204 and a second feedback circuit is implemented between transducer 211 and emitter 206, the feedback circuits being implemented substantially as described above for feedback loop 164 (FIG. 4). According to some embodiments, each feedback circuit is implemented so as to maintain each of the power levels received by transducer 212 and transducer 211 substantially constant. Alternatively or additionally, each feedback circuit maintains a parameter measuring quality of information transfer for its respective beam at an optimum level. Such parameters include a signal-to-noise ratio and a bit error rate, and their use is described in more detail with respect to FIG. 12 below. It will be appreciated that because of the presence of the separate feedback circuits, characteristics of optical radiation emitted from emitters 204 and 206, such as a power level and/or a bandwidth, will typically be different.

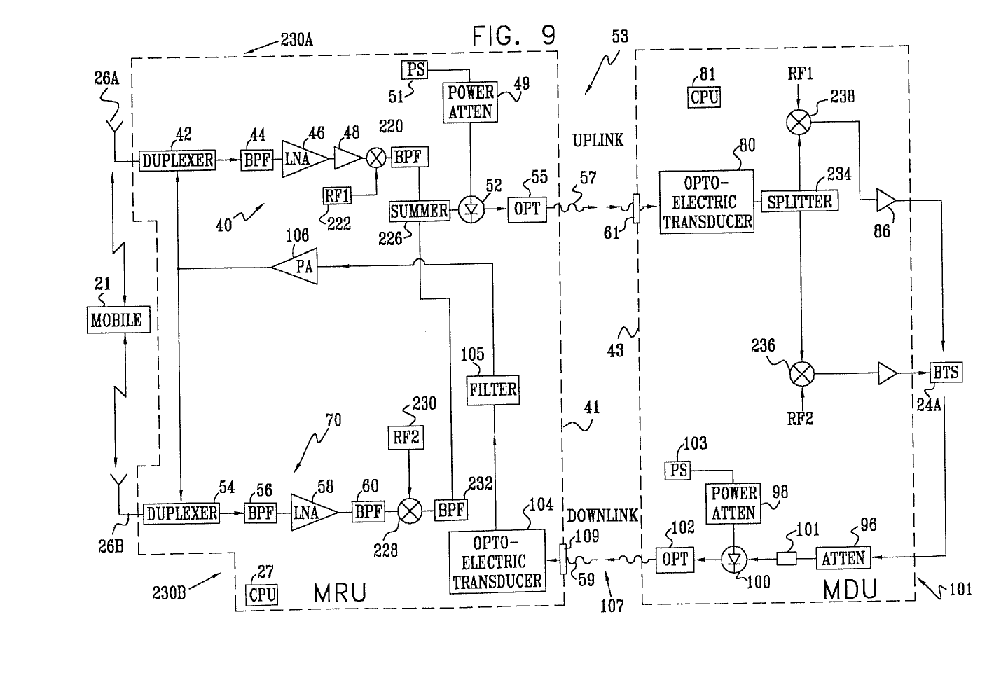

FIG. 9 is a schematic block diagram of link 230A between antenna 26A and BTS 24A, and of link 230B between antenna 26B and BTS 24A according to a further alternative embodiment of the present invention. Apart from the differences described below, the operation of each of links 230A and 230B is generally similar to that of links 34A and 34B (FIGS. 1A,-4), so that components indicated by the same reference numerals in links 34A, 34B and links 230A, 230B are generally identical in construction and in operation. The description hereinbelow assumes that links 230A and 230B are implemented in MRU 41 and MDU 43 by adding and replacing components in links 34A and 34B.

In MRU 41 the output of amplifier 48, herein termed RF signal 1, is fed to a mixer 220, which also receives a first local sub-carrier frequency RF 1 from a first signal generator 222. Mixer 220 generates a modulated signal, which is filtered by a BPF 224 before being provided as a modulated RF 1 input to a summer 226. Similarly, the output of BPF 60, herein termed RF signal 2, is fed to a mixer 228, which also receives a second local sub-carrier frequency RF2 from a second signal generator 230. Mixer 228 generates a modulated signal, which is filtered by a BPF 232 and then input as a modulated RF2 input to summer 226. Summer 226 adds its two inputs and a summed resultant RF signal is supplied to emitter 52, which operates substantially as described with reference to FIGS. 2-4 above. (In MRU 41 components 220, 222, 224, 226, 228, 230, and 232 replace components 50, 62, 64, and 65.)

In MDU 43, transducer 80 generates a recovered resultant RF signal and inputs the resultant to a splitter 234. Splitter 234 is implemented so as to recover the modulated RF1 and RF2 signals as separate signals. The separated signals are respectively input to mixers 238 and 236. Mixer 238 also receives a signal substantially equal in frequency to first sub-carrier RF1, and uses this signal to recover RF signal 1. Similarly, mixer 236 receives a signal substantially equal in frequency to second sub-carrier RF2, and recovers RF signal 2. (In MDU 43 components 234, 236, and 238 replace components 82, 84, 90, and 92.) RF signal 1 and RF signal 2 are then transmitted via respective amplifiers 86 and 94 to BTS 24A.

Referring back to FIG. 1, it will be appreciated that any of the BTS-BSC links 32, BSC-BSC link 38, or BSC-External Communications systems link 30 may be implemented from one or more systems described above with reference to FIGS. 2-9.

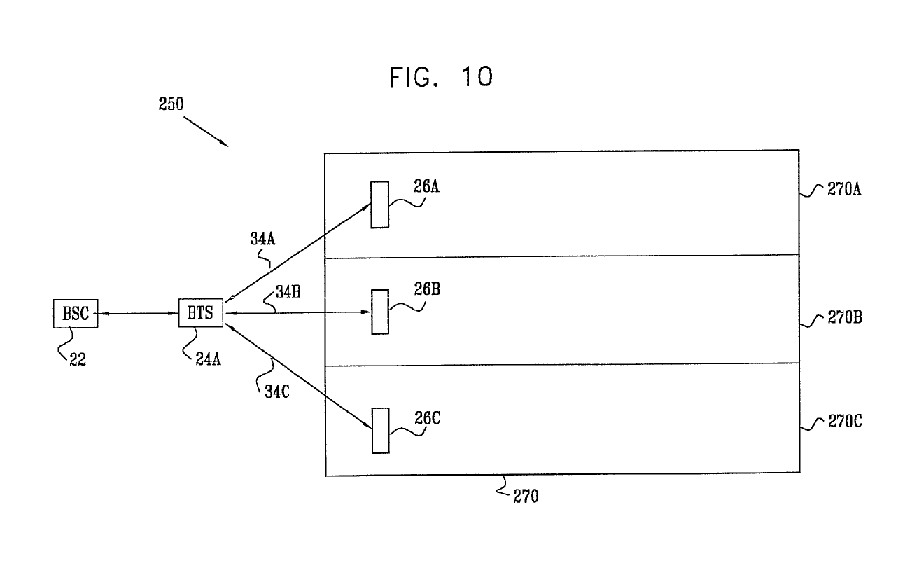

FIG. 10 is a schematic diagram illustrating connections between network-elements of a cellular network 250, according to an alternative embodiment of the present invention. Apart from the differences described below, the operation of network 250 is generally similar to that of network 20 (FIG. 1), so that components indicated by the same reference numerals in both networks 20 and 250 are generally identical in construction and in operation. Network 250 is installed in a building 270, and antennas 26A, 26B, and 26C are positioned so as to cover specific regions within the building, such as respective floors 270A, 270B, and 270C. Typically, building 270 acts as a shield to external communicating radiation, so that antennas must be positioned within the building to cover the building interior. According to some embodiments, regions covered by antennas 26A, 26B, and 26C at least partially overlap. Links 34A, 34B, and 34C are implemented according to any of the systems described above with respect to FIGS. 2-9, or a combination of such systems.

In some embodiments of the present invention, antennas within a network such as network 20 or network 250 are allocated to a base station on a dynamic basis. Antennas such as antennas 26A, 26B, and 26C (network 20 or network 250) are assigned channels and/or communication bandwidth on the basis of one or more pre-determined parameters, such as demand for use. In some preferred embodiments, the assignment is controlled by a central processing unit within BTS 24A. For example, at a particular time in building 270 (FIG. 10) ground floor 27C may experience a large demand, while floors 27A and 27B may experience a low demand. In this case antenna 26C is assigned more bandwidth, and antennas 26A and 26B are assigned less bandwidth.

In addition to dynamically assigning antennas coupled to a single BTS, some embodiments of the present invention assign antennas across the network, via the communication links described above. Assignments of this form enable networks to cope with varying loads in different sections of the network, without having to install equipment that in general may be under-utilized, by transferring capacity across the network. For example, if in network 20 (FIG. 1) antennas 26D and 26H experience demand which is greater than that which BTS 24B is able to handle, BTS 24B informs its local BSC 22. BSC 22 then checks to see if there is a BTS, such as BTS 24C, in network 20 which has “spare” capacity. In this case BTS 24C is coupled to BTS 24B (via links 32 and link 38) so that both BTSs operating together are able to handle the demand on antennas 26D and 26H. A similar system may be used by a single BTS such as BTS 24A to transfer capacity between antennas, such as antennas 26A, 26B, and 26C, which are directly coupled to the BTS.

It will be appreciated that where more than one cellular system is implemented in network 20, capacity may be transferred between the systems by methods described hereinabove with respect to FIG. 10. Alternative multiple systems will be apparent to those skilled in the art, and include, but are not limited to, two or more cellular systems (such as a CDMA and a TDMA system, or two CDMA systems which may be operated by different operators), two or more frequency bands, and/or two or more multiplexing methods, being implemented in network 20.

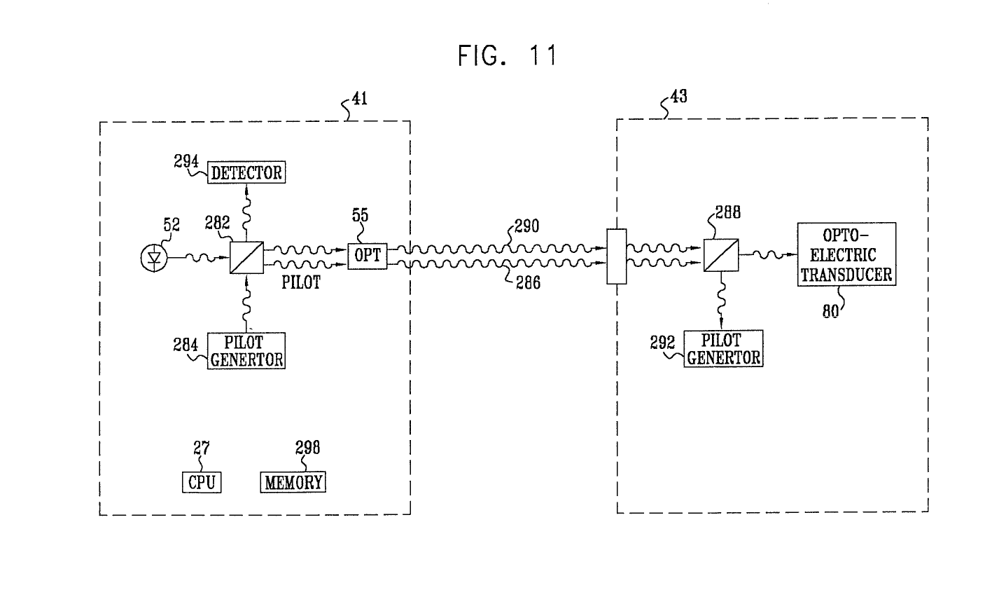

FIG. 11 is a schematic diagram of a coupling 280 between emitter 52 and opto-electric transducer 80 (FIG. 2), according to an embodiment of the present invention. Coupling 280 comprises elements in MRU 41 and MDU 43 in addition to those described hereinabove with reference to FIG. 2. For clarity, only elements referred to in the following description of coupling 280 are shown in FIG. 11. Coupling 280 comprises a beam combiner 282 positioned between emitter 52 and optics 55, in MRU 41. The beam combiner receives an optical pilot signal 285 from a pilot signal emitter 284. In some embodiments, emitter 284 emits at a wavelength different from emitter 52, in which case combiner 282 is implemented to selectively reflect a high percentage, such as on the order 90%, of the pilot signal to optics 55, and to transmit the remainder to a pilot level monitor 294. The level generated by monitor 294 is read by CPU 27, which is thus able to monitor a transmit level of the pilot signal.

Combiner 282 is implemented to transmit substantially all light received from emitter 52. Most preferably, emitter 52, beam combiner 282, emitter 284 and optics 55 are arranged so that an uplink optical pilot signal 286 transmitted from optics 55 is substantially collinear with an uplink beam 290 from emitter 52.

Coupling 280 also comprises a beam separator 288 positioned between optics 61 and opto-electric transducer 80, in MDU 43. In some embodiments, separator 288 is implemented to transmit substantially all of uplink beam 290 to transducer 80, and to reflect substantially all of optical pilot signal 286. Separator 288 reflects optical pilot signal 286 to a pilot detector 292 which measures a level of the power of the received pilot signal, the level being read by CPU 81. CPU 81 is thus able to monitor a receive level of pilot signal 286. The transmit and receive pilot signal levels monitored by CPU 27 and CPU 81 respectively are used to optimize a transmission power level and a channel bandwidth for the modulated carrier transmitted by emitter 52. The optimization is necessary because of varying attenuation occurring in the atmospheric optical path between MRU 41 and MDU 43, and is implemented via a mapping between the received pilot power level and a parameter measuring quality of information transferred by the carrier. The mapping is stored in a memory 296 in MDU 43 and/or a memory 298 in MRU 41, the memories being used by CPU 81 and/or CPU 27. Details of the optimization and the mapping are described below with reference to FIG. 12.

It will be appreciated that instead of a separate optical pilot signal, a pilot channel may be incorporated as a sub-carrier in the beam transmitted from emitter 52 to transducer 80, so that either the optical pilot signal or the pilot channel act as a pilot signal between the emitter and the transducer. The pilot channel may be analyzed in generally the same manner as described hereinabove with respect to optical pilot signal 286. It will be further appreciated that either an optical pilot signal system or a pilot channel system may also be used to compensate for pointing loss, described hereinabove.

FIG. 12 is a flowchart showing steps of a process 300 for optimizing transmissions from emitter 52 when coupling 280 is implemented, according to an embodiment of the present invention. Process 300 is most preferably implemented by CPU 81 and CPU 27 communicating as necessary.

In a calibration step 301, received pilot signal 286 power levels (pilot-powers) are mapped to received uplink beam signal-to-noise ratios (uplink-SNRs). The mapping is prepared by varying transmitted pilot signal power levels and transmitted uplink beam power levels monotonically, the two transmitted power levels preferably being set to be linearly dependent, most preferably substantially equal. For each transmitted pilot signal power level the corresponding transmitted uplink beam power level is set, and received pilot signal power levels and uplink-SNRs are measured. In some preferred embodiments, the calibration is performed prior to MRU 41 and MDU 43 becoming operational in their communication network, and is stored in memory 296 and/or memory 298.

In a measurement step 302, during operation of MRU and MDU 43, the pilot-power is measured by detector 292, and a corresponding uplink-SNR is found from the calibrated values.

In a first comparison 304, the uplink-SNR is evaluated to determine if it is too high, i.e., if it is higher than necessary in order to transmit at a maximum communication bandwidth for the uplink beam. The maximum communication bandwidth for the uplink beam is set when the network within which MRU 41 and MDU 43 is implemented. If the uplink-SNR is too high, then in a reduction step 306 the transmitter powers of emitter 52 and of emitter 284 are reduced. The reduction is performed by CPU 81 communicating with CPU 27, and the reduction is implemented by CPU 27 reducing the power levels by a predetermined adjustment level each time step 306 is invoked.

If the uplink-SNR is not too high, then in a second comparison 308, the uplink-SNR is checked to see if it is below a required SNR-level, preferably preset at network installation, for optimum performance of the uplink beam. If the uplink-SNR is not below the required SNR-level, process 300 returns to step 302, and CPU 81 and detector 292 continue to monitor the uplink-SNR as described above using steps 304, 306, and 308.

If the uplink-SNR is below the required SNR-level, then in a third comparison 310, the transmitter power of emitter 52 is checked to see if it is at a preset maximum value. In some embodiments, the maximum value is set to be below a value at which eye damage can be caused. If the power is not at the maximum value, then in an increase step 312 the transmitter powers of emitter 52 and of emitter 284 are increased, preferably by the predetermined adjustment level.

If emitter 52 is at its maximum power level, then in a first bandwidth step 314 a maximum possible communication bandwidth is calculated assuming the minimum required SNR-level (used in comparison 308) is implemented.

In a second bandwidth step 316, CIPU 27 and CPU 81 and/or other processing units in network-elements in the communication network reduce the communication bandwidth between MRU 41 and MDU 43 to the maximum possible value. Reducing the communication bandwidth typically comprises reducing a number of channels and/or codes and/or frequencies allocated, so that overall capacity is reduced while the remaining bandwidth maintains the minimum required SNR value.

Process 300 has been described assuming that the communication between MRU 41 and MDU 43 is a substantially analog communication, where uplink beam 290 is analog modulated. It will be appreciated that a process similar to process 300 can be applied to coupling 280 for a digital communication system. According to some embodiments, instead of using SNR, as described for calibration step 301, and steps 302, 304, and 308, a bit error rate (BER) criterion is used. Thus, a calibration mapping of BER and received pilot-power is generated in step 301, and in comparison 308 the BER is checked to see if it is above a preset required BER-level.

In the case of digital communication, the bandwidth adaptation process of steps 314 and 316 is replaced by a procedure wherein a gain of a forward error correction (FEC) code is changed. The FEC gain determines an information rate transferred via uplink beam 290, and as the FEC gain increases, the information rate decreases. An information rate decrease is implemented by enabling fewer users to use the communication link, while maintaining a satisfactory quality of service for the reduced number of users.

It will be appreciated that when process 300 is applied to a substantially analog communication, SNR of the optical carrier is used as a parameter measuring quality of information transferred by the carrier. When process 300 is applied to a substantially digital communication, BER is used as the parameter measuring quality of information transferred by the carrier.

It will be understood that a process substantially similar to process 300 applies if optical pilot signal 286 is replaced by a pilot channel on a beam from emitter 52 to transducer 80.

Those skilled in the art will be able to adapt the descriptions and modifications given above, in reference to FIG. 11 and FIG. 12 for an uplink connection, to implementing a downlink connection.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

What is claimed is:

1. A method for transferring information within a cellular communications network, comprising acts of:
transmitting an optical carrier from a first network-element of the network;
modulating the optical carrier with the information;
detecting the modulated optical carrier in an avalanche photo-diode (APD) comprised in a second network-element of the network so as to recover the information; and
altering a gain of the APD responsive to a level of the optical carrier so as to prevent saturation of the APD.

2. A method according to claim 1, wherein the act of transmitting the optical carrier comprises transmitting coherent radiation from a laser diode.

3. A method according to claim 1, wherein the act of transmitting the optical carrier comprises transmitting incoherent radiation from a light emitting diode.

4. A method according to claim 1, wherein the act of modulating the optical carrier comprises modulating the carrier with one or more sub-carriers comprising the information.

5. A method according to claim 1, wherein the act of detecting the modulated optical carrier comprises measuring an output level generated by the APD, and wherein altering the gain of the APD responsive to the level comprises altering the gain responsive to the output level.

6. A method according to claim 5, wherein the act of measuring the output level comprises utilizing a central processing unit (CPU) comprised in the second network-element to measure an average output level, and wherein altering the gain responsive to the output level comprises utilizing the CPU to alter the gain.

7. A method according to claim 1, wherein the act of detecting the modulated optical carrier comprises measuring an output level of the APD, and wherein transmitting the optical carrier comprises varying a power level of the optical carrier responsive to the output level of the APD.

8. A method according to claim 7, wherein the act of varying the power level of the optical carrier comprises:
transmitting a reverse optical carrier from the second network-element to the first network-element;
modulating the reverse optical carrier with an indication of the output level of the APD; and
varying the power output responsive to the indication.

9. A method according to claim 8, further comprising the act of modulating the reverse optical carrier with additional information.

10. A method according to claim 1, wherein the act of transmitting the optical carrier comprises transmitting the optical carrier via a path between the first network-element and the second network-element comprising free space.

11. A method according to claim 1, wherein the act of transmitting the optical carrier comprises transmitting the optical carrier via a path between the first network-element and the second network-element comprising a fiber optic.

12. A method according to claim 1, further comprising the act of altering the gain of the APD responsive to at least one of an optical background noise level of the optical carrier and an aggregate system noise, so as to prevent saturation of the APD.

13. Apparatus for transferring information within a cellular communications network, comprising:
a first network-element of the network, comprising:
an emitter which is adapted to transmit an optical carrier; and
a modulator which is adapted to modulate the optical carrier with the information; and
a second network-element of the network, comprising:
an avalanche photo-diode (APD) which is adapted to detect the modulated optical carrier so as to recover the information; and
a gain controller which is adapted to alter a gain of the APD, responsive to a level of the optical carrier, so as to prevent saturation of the APD.

14. Apparatus according to claim 13, wherein the emitter comprises a laser diode which transmits coherent radiation.

15. Apparatus according to claim 13, wherein the emitter comprises a light emitting diode which transmits incoherent radiation.

16. Apparatus according to claim 13, wherein the modulator is adapted to modulate the optical carrier with one or more sub-carriers comprising the information.

17. Apparatus according to claim 13, wherein the gain controller comprises a detector which is adapted to measure an output level generated by the APD, and wherein the gain controller is adapted to alter the gain of the APD responsive to the output level.

18. Apparatus according to claim 17, wherein the second network-element comprises a central processing unit (CPU) which is adapted to measure the output level as an average output level, and to alter the gain responsive to the average output level.

19. Apparatus according to claim 13, wherein the gain controller is adapted to measure an output level of the APD, and wherein the emitter is adapted to vary a power output of the optical carrier responsive to the output level of the APD.

20. Apparatus according to claim 19, wherein the second network-element comprises a reverse-transmitting emitter which is adapted to transmit a reverse optical carrier which conveys an indication of the output level of the APD from the second network-element to the first network-element, and wherein the emitter is adapted to vary the power output responsive to the indication.

21. Apparatus according to claim 20, wherein the second network-element comprises a reverse modulator which modulates the reverse optical carrier with additional information.

22. Apparatus according to claim 13, wherein the emitter is adapted to transmit the optical carrier via a path between the first network-element and the second network-element comprising free space.

23. Apparatus according to claim 13, wherein the emitter is adapted to transmit the optical carrier via a path between the first network-element and the second network-element comprising a fiber optic.

24. Apparatus according to claim 13, wherein the gain controller is adapted to alter the gain of the APD responsive to at least one of an optical background noise level of the optical carrier and an aggregate system noise, so as to prevent saturation of the APD.

25. Apparatus for transferring information within a cellular communications network, comprising:
a first network-element of the network, comprising:
a first amplifier which is adapted to receive and amplify a radio-frequency (RF) signal so as to generate a first-amplified-RF-signal;
a detector which indicates attainment of a predetermined level of the received-RF-signal;
a first gain device which is adapted to alter a gain of the first amplifier by a predetermined gain-value responsive to the attainment of the predetermined level; and
an optical transmitter which modulates an optical carrier with the first-amplified-RF-signal and which transmits the modulated carrier; and
a second network-element of the network, comprising:
an optical receiver which receives the modulated carrier and generates a recovered-RF-signal therefrom;
a second amplifier which is adapted to receive and amplify the recovered-RF-signal so as to generate a second-amplified-RF-signal; and
a second gain device which is adapted to alter a gain of the second amplifier by a value substantially equal to a negative of the predetermined gain-value responsive to the attainment of the predetermined level at the first network-element.

26. Apparatus according to claim 25, wherein the detector generates a change-gain signal responsive to the attainment of the predetermined level, and wherein the optical transmitter conveys the change-gain signal to the optical receiver.

27. Apparatus according to claim 26, wherein the second network-element comprises a central processing unit (CPU) which incorporates the second gain device into the second amplifier responsive to the received change-gain signal.

28. Apparatus for receiving information transmitted in a cellular communications network, comprising:
an optical assembly which is adapted to receive an optical carrier modulated with the information and output the received-modulated-carrier;
a first optical unit which is coupled to receive the received-modulated-carrier at a first end of the first optical unit and to convey the received-modulated-carrier therein;
a first receiver which is coupled to a second end of the first optical unit to receive a first fraction of the received-modulated-carrier and which, responsive thereto, is adapted to generate a first output representative of the information;
a second optical unit which is coupled to the first optical unit so as to convey a second fraction of the received-modulated-carrier into the second optical unit;
a second receiver which is coupled to the second optical unit so as to receive the second fraction of the received-modulated-carrier and which, responsive thereto, is adapted to generate a second output representative of the information; and
a switch which selects from the first and the second outputs responsive to a level of the received-modulated-carrier.

29. Apparatus according to claim 28, wherein a ratio of the first fraction to the second fraction is comprised in an approximate range between 30:1 and 300:1.

30. Apparatus according to claim 28, and comprising:
a third optical unit which is coupled to the second optical unit so as to convey a third fraction of the received-modulated-carrier into the third optical unit; and
a third receiver which is coupled to the third optical unit so as to receive the third fraction of the received-modulated-carrier and which, responsive thereto, is adapted to generate a third output representative of the information,
and wherein the switch selects from the first, second, and third outputs responsive to the level of the received-modulated-carrier.

31. Apparatus according to claim 30, wherein a ratio of the second fraction to the third fraction is comprised in an approximate range between 30:1 and 300:1.

32. Apparatus according to claim 28, and comprising:
a third optical unit which is coupled to the first optical unit so as to convey a third fraction of the received-modulated-carrier into the third optical unit; and
a third receiver which is coupled to the third optical unit so as to receive the third fraction of the received-modulated-carrier and which, responsive thereto, is adapted to generate a third output representative of the information,
and wherein the switch selects from the first, second, and third outputs responsive to the level of the received-modulated-carrier and to an ability to operate of the second and third receivers.

33. Apparatus according to claim 28, wherein at least one of the first and second optical units comprises a fiber optic.

34. Apparatus for transferring information within a cellular communications network, comprising:
a first network-element of the network, comprising:
an analog-to-digital converter (ADC) which is adapted to convert a radio-frequency (RF) signal to a digital signal, the RF signal being receivable from a transceiver operative within the network;
an optical modulator which is coupled to receive the digital signal and is adapted to modulate an optical carrier with the signal; and
a transmitter which is adapted to transmit the modulated optical carrier; and a second network-element of the network, comprising:
a receiver which is coupled to receive the modulated optical carrier;
a demodulator which is adapted to recover the digital signal from the modulated optical carrier; and
a digital-to-analog converter (DAC) which is adapted to convert the digital signal so as to recover the RF signal.

35. Apparatus according to claim 34, wherein a sampling rate of the ADC is equal or greater than approximately twice a frequency of the RF signal bandwidth.

36. Apparatus according to claim 34, wherein the digital signal comprises a compressed digital signal generated by the ADC, and wherein the DAC is adapted to decompress the compressed digital signal.

37. Apparatus for transferring information within a cellular communications network, comprising:
a first network-element of the network, comprising:
a splitter, which is adapted to receive an initial radio-frequency (RF) signal comprising the information and to split the signal into a first RF signal and a second RF signal;
a first optical transmitter which is coupled to modulate a first optical carrier with the first RF signal and to transmit the first modulated optical carrier; and
a second optical transmitter which is coupled to modulate a second optical carrier with the second RF signal and to transmit the second modulated optical carrier;
a second network-element of the network, comprising:
a first optical receiver which is adapted to receive and demodulate the first modulated optical carrier to recover the first RF signal;
a second optical receiver which is adapted to receive and demodulate the second modulated optical carrier to recover the second RF signal; and
a summer which is coupled to add the first and second recovered RF signals so as to regenerate the initial RF signal; and
a first feedback network, coupling the first optical receiver to the first optical transmitter, which alters a first characteristic of the first modulated optical carrier responsive to a first parameter indicative of a first quality of information transferred by the first modulated optical carrier measured at the second network-element.

38. Apparatus according to claim 37, and comprising a second feedback network which couples the second optical receiver to the second optical transmitter, and which alters a second characteristic of the second modulated optical carrier responsive to at least one of a second parameter indicative of a second quality of information transferred by the second modulated optical carrier measured at the second network-element and the first parameter.

39. Apparatus according to claim 37, wherein a level of the first RF signal is different from the level of the second RF signal.

40. Apparatus according to claim 37, wherein a frequency of the first RF signal is different from the frequency of the second RF signal.

41. Apparatus according to claim 37, wherein a parameter of the first modulated optical carrier is different from the parameter of the second modulated optical carrier, wherein the parameter is chosen from a group comprising a wavelength, a polarization, and a power level.

42. Apparatus according to claim 37, wherein the first modulated optical carrier comprises substantially analog modulation, wherein the first characteristic comprises at least one of a bandwidth and a level of the first modulated optical carrier, and wherein the first parameter comprises a signal-to-noise ratio of the first modulated optical carrier.

43. Apparatus according to claim 37, wherein the first modulated optical carrier comprises substantially digital modulation, wherein the first characteristic comprises at least one of a bandwidth and a level of the first modulated optical carrier, and wherein the first parameter comprises a bit-error-rate of the first modulated optical carrier.

44. Apparatus for transferring information within a cellular communications network, comprising:
a first network-element of the network, comprising:
a first mixer which is adapted to modulate a first RF sub-carrier with a first RF signal;
a second mixer which is adapted to modulate a second RF sub-carrier with a second RF signal;
a summer which is coupled to add the first and second modulated sub-carriers to generate a combined RF signal; and
an optical transmitter which is coupled to transmit an optical carrier modulated with the combined RF signal; and
a second network-element of the network, comprising:
an optical receiver which is adapted to receive the modulated optical carrier and to recover the combined RF signal;
a splitter which is coupled to recover from the combined RF signal the first modulated sub-carrier and the second modulated sub-carrier as separate signals;
a third mixer which is adapted to receive the first modulated sub-carrier and to recover the first RF signal; and
a fourth mixer which is adapted to receive the second modulated sub-carrier and to recover the second RF signal.

45. Apparatus according to claim 44, wherein the third mixer receives the first RF sub-carrier so as to recover the first RF signal, and wherein the fourth mixer receives the second RF sub-carrier so as to recover the second RF signal.

46. A method for transferring information within a cellular communications network, comprising the acts of:
receiving and amplifying, in a first amplifier comprised in a first network-element of the network, a radio-frequency (RF) signal so as to generate a first-amplified-RF-signal;
altering a gain of the first amplifier by a predetermined gain-value, responsive to the RF signal attaining a predetermined level;
modulating an optical carrier with the first-amplified-RF-signal and transmitting the modulated carrier;
receiving in an optical receiver comprised in a second network-element of the network the modulated carrier and generating a recovered-RF-signal therefrom;
receiving and amplifying the recovered-RF-signal in a second amplifier so as to generate a second-amplified-RF-signal; and
altering a gain of the second amplifier by a value substantially equal to a negative of the predetermined gain-value, responsive to the RF signal attaining the predetermined level.

47. A method according to claim 46, and further comprising the acts of generating a change-gain signal in the first network-element responsive to the RF signal attaining the predetermined level, and conveying the change-gain signal to the second network-element.

48. A method for receiving information transmitted in a cellular communications network, comprising the acts of:
receiving in an optical assembly an optical carrier modulated with the information and outputting therefrom the received-modulated-carrier;
coupling the received-modulated-carrier into a first end of a first optical unit and conveying the received-modulated-carrier therein;
receiving a first fraction of the received-modulated-carrier in a first receiver coupled to a second end of the first optical unit and responsive thereto generating a first output representative of the information;
coupling a second optical unit to the first optical unit;
conveying a second fraction of the received-modulated-carrier into the second optical unit;
receiving in a second receiver coupled to the second optical unit the second fraction of the received-modulated-carrier and, responsive thereto, generating a second output representative of the information; and
selecting between the first and the second outputs responsive to a level of the received-modulated-carrier.

49. A method according to claim 48, wherein the acts of coupling comprise forming a ratio of the first fraction to the second fraction that is comprised in an approximate range between 30:1 and 300:1.

50. A method according to claim 48, wherein at least one of the first and second optical units comprises a fiber optic.

51. A method for transferring information within a cellular communications network, comprising the acts of:
converting, in an analog-to-digital converter (ADC), a radio-frequency (RF) signal to a digital signal, the RF signal being receivable by a transceiver operative within the network;
modulating a n optical carrier with the digital signal; and
transmitting the modulated optical carrier from a transmitter comprised in a first network-element of the network; and
receiving and demodulating the modulated optical carrier in a receiver comprised in a second network-element of the network, so as to recover the digital signal; and
converting the digital signal in a digital-to-analog converter (DAC) so as to recover the RF signal.

52. A method according to claim 51, wherein the act of converting comprises sampling at a sampling rate of the ADC that is equal to or greater than approximately twice a frequency of the RF signal.

53. A method according to claim 51, wherein the act of converting in the ADC comprises compressing the digital signal to form a compressed digital signal and the act of converting in the DAC comprises decompressing the compressed digital signal.

54. A method for transferring information within a cellular communications network, comprising the acts of:
receiving an initial radio-frequency (RF) signal comprising the information and splitting the signal into a first RF signal and a second RF signal;
modulating a first optical carrier with the first RF signal to produce a first modulated optical carrier and transmitting the first modulated optical carrier from a first optical transmitter in a first network-element of the network;
modulating a second optical carrier with the second RF signal to produce a second modulated optical carrier and transmitting the second modulated optical carrier from a second optical transmitter in the first network-element;
receiving in a first optical receiver in a second network-element of the network the first modulated optical carrier and demodulating the first modulated optical carrier to recover the first RF signal;
receiving in a second optical receiver in the second network-element the second modulated optical carrier and demodulating the second modulated optical carrier to recover the second RF signal;
coupling the first optical receiver to the first optical transmitter by a first feedback network which alters a first characteristic of the first modulated optical carrier, responsive to a first parameter indicative of a first quality of information transferred by the first modulated optical carrier measured at the second network-element; and
adding the first and second recovered RF signals to regenerate the initial RF signal.

55. A method according to claim 54, and comprising the act of coupling the second optical receiver to the second optical transmitter by a second feedback network which alters a second characteristic of the second modulated optical carrier, responsive to at least one of a second parameter indicative of a second quality of information transferred by the second modulated optical carrier measured at the second network-element and the first parameter.

56. A method according to claim 54, wherein the act of splitting comprises providing a level of the first RF signal that is different from the level of the second RF signal.

57. A method according to claim 54, wherein the act of splitting comprises providing a frequency of the first RF signal that is different from the frequency of the second RF signal.

58. A method according to claim 54, wherein the acts of modulating comprise providing a parameter of the first modulated optical carrier that is different from a parameter of the second modulated-optical carrier, wherein the parameter is chosen from a group comprising a wavelength, a polarization, and a power level.

59. A method according to claim 54, wherein the first modulated optical carrier comprises substantially analog modulation, wherein the first characteristic comprises at least one of a bandwidth and a level of the first modulated optical carrier, and wherein the first parameter comprises a signal-to-noise ratio of the first modulated optical carrier.

60. A method according to claim 54, wherein the first modulated optical carrier comprises substantially digital modulation, wherein the first characteristic comprises at least one of a bandwidth and a level of the modulated first optical carrier, and wherein the first parameter comprises a bit-error-rate of the first modulated optical carrier.

61. A method for transferring information within a cellular communications network, comprising the acts of:
modulating a first RF sub-carrier with a first RF signal to form a first modulated sub-carrier;
modulating a second RF sub-carrier with a second RF signal to form a second modulated sub-carrier;
adding the first and second modulated sub-carriers to generate a combined RF signal;
transmitting an optical carrier modulated with the combined RF signal from a first network-element of the network;
receiving the modulated optical carrier in a second network-element of the network and recovering the combined RF signal;
separating the combined RF signal into the first modulated sub-carrier and the second modulated sub-carrier;
recovering the first RF signal from the first modulated sub-carrier; and
recovering the second RF signal from the second modulated sub-carrier.

62. A method for allocating capacity to a network-element operating in a cellular communications network, comprising the acts of:
providing a plurality of spatially fixed network-elements, each network-element having a respective capacity for transmitting and receiving signals compatible with the cellular communications network;
coupling pairs of the plurality of network-elements by respective optical carriers, each carrier being modulated so as to convey the signals between the respective coupled pair of network-elements; and
transferring at least some of the capacity of the coupled network-elements therebetween via the optical carriers, responsive to a level of the signals detected by the plurality of network-elements.

63. A method according to claim 62, wherein the spatially fixed network-elements are implemented to operate a plurality of cellular systems, and wherein transferring at least some of the capacity comprises transferring capacity between the cellular systems, and wherein the plurality of cellular systems comprises any of systems operating on two or more frequency bands, systems operating by two or more multiplexing methods, and systems operated by two or more different operators.

64. Apparatus for allocating capacity in a cellular communications network, comprising:
a first plurality of spatially fixed network-elements, each network-element having a respective capacity for transmitting and receiving signals compatible with the cellular communications network; and
a second plurality of optical carriers, each carrier coupling a pair of the network-elements and being modulated so as to convey the signals therebetween, and being adapted to transfer at least some of the capacity of the coupled network-elements therebetween, responsive to a level of the signals detected by the network-elements.

65. A method for transferring information within a cellular communications network, comprising the acts of:
transmitting an optical carrier from a first network-element of the network to a second network-element of the network;
modulating the optical carrier with the information so as to transfer the information from the first network-element to the second network-element;
transmitting a pilot signal from the first network-element to the second network-element;
measuring a received power level of the pilot signal at the second network-element;
generating a mapping between the received power level of the pilot signal and a parameter indicative of a quality of the information transferred from the first network-element to the second network-element; and
adjusting at least one of a transmitted power level of the optical carrier and a communication bandwidth of the optical carrier, responsive to the received power level of the pilot signal and the mapping, so as to maintain a predetermined minimum quality of the information transferred from the first network-element to the second network-element.

66. A method according to claim 65, wherein the act of transmitting the pilot signal comprises transmitting an optical pilot signal substantially collinearly with the optical carrier, and with a wavelength substantially different from the wavelength of the optical carrier.

67. A method according to claim 65, wherein the act of transmitting the pilot signal comprises transmitting a pilot channel as a sub-carrier on the optical carrier.

68. A method according to claim 65, wherein the act of modulating the optical carrier comprises modulating the optical carrier with an analog modulation, and wherein the parameter indicative of the quality comprises a signal-to-noise ratio of the optical carrier.

69. A method according to claim 65, wherein the act of modulating the optical carrier comprises modulating the optical carrier with a digital modulation, and wherein the parameter indicative of the quality comprises a bit error rate of the optical carrier.

70. Apparatus for transferring information within a cellular communications network, comprising:
a first network-element of the network, comprising:
an optical emitter which transmits an optical carrier modulated with the information as a modulated optical carrier;
a pilot signal generator which transmits a pilot signal; and
a first central processing unit (CPU) which controls the emitter and the pilot generator;
a second network-element of the network, comprising:
a transducer which receives the modulated optical carrier and generates recovered information therefrom;
a detector which measures a received power level of the pilot signal;
a second CPU which receives the measured power level; and
a memory which stores a mapping between the received power level of the pilot signal and a parameter indicative of a quality of the recovered information, at least one of the first and second CPUs being adapted to adjust at least one of a transmitted power level of the optical carrier and a communication bandwidth of the optical carrier, responsive to the received power level of the pilot signal and the mapping, so as to maintain a predetermined minimum quality of the recovered information.

71. Apparatus according to claim 70, wherein the pilot signal comprises an optical pilot signal which is transmitted substantially collinearly with the modulated optical carrier, and which comprises a wavelength substantially different from the wavelength of the modulated optical carrier.

72. Apparatus according to claim 70, wherein the pilot signal comprises a pilot channel operative as a sub-carrier on the optical carrier.

73. Apparatus according to claim 70, wherein the modulated optical carrier comprises an analog modulation, and wherein the parameter indicative of the quality comprises a signal-to-noise ratio of the modulated optical carrier.

74. Apparatus according to claim 70, wherein the modulated optical carrier comprises a digital modulation, and wherein the parameter indicative of the quality comprises a bit error rate of the modulated optical carrier.
